(19) United States
(12) Patent Application Publication
(10) Pub. No.: US 2025/0327956 A1
(43) Pub. Date: Oct. 23, 2025

(54) FILTER UNIT AND METHOD FOR MANUFACTURING FILTER UNIT

(71) Applicants: PLATINUM OPTICS TECHNOLOGY INC., Taoyuan City (CN); IRIDIUM OPTICS TECHNOLOGY NANTONG INC., Hai'an City (CN)

(72) Inventors: Yu-Kun HSIAO, Hai'an City (CN); Cheg-Che Lee, Hai'an City (CN); Chia-Fu Liu, Hai'an City (CN); Wei-Chung Wu, Hai'an City (CN); Cheng-An Huang, Hai'an City (CN)

(21) Appl. No.: 19/071,886

(22) Filed: Mar. 6, 2025

(30) Foreign Application Priority Data
Apr. 22, 2024 (CN) 202410479882.8

(51) Int. Cl. G02B 5/22

(52) U.S. Cl. CPC G02B 5/22

(57) ABSTRACT

Disclosed are a filter unit and a method for manufacturing a filter unit. The filter unit includes a substrate, an organic dye layer, an inorganic optical layer, and a light shielding structure. The organic dye layer is arranged on a side of the substrate, the light shielding structure is arranged on a side, opposite to the substrate, of the organic dye layer, and a portion of the inorganic optical layer is located between the organic dye layer and the light shielding structure, the light shielding structure and the inorganic optical layer covering the light shielding structure together form a light blocking portion, and the light blocking portion has a reflectivity of 1% or less for a light beam with a wavelength range of 500 nm to 775 nm when an incident angle is in a range of 0 to 5 degrees.

### CROSS-REFERENCE TO RELATED APPLICATIONS

This application claims priority to Chinese Patent Application No. 202410479882.8, filed on Apr. 22, 2024, which is hereby incorporated by reference in its entirety.

### TECHNICAL FIELD

The present application relates to a method for manufacturing an optical element and an optical element, in particular to a filter unit and a method for manufacturing a filter unit.

### BACKGROUND

The light shielding structure of the existing filter unit is easily damaged during a relevant manufacturing process of the filter unit (for example, the cleaning process), and therefore, the light shielding structure of the final filter product may not be able to properly perform its predetermined function. Furthermore, when the filter unit is transported or stored, the side of the filter unit having the light shielding structure is usually attached to the tape temporarily to protect the filter unit from contamination or damage. In this case, when the tape is torn off from the filter unit, if the adhesive force between the tape and the light shielding structure is too high, residual glue easily leaves on the surface of the filter unit (especially the light shielding structure), or the light shielding structure is torn off together with the tape and consequently is damaged, thereby greatly reducing the yield of the filter unit.

### SUMMARY

The application provides a filter unit and a method for manufacturing a filter unit.

A first aspect provides a filter unit, which includes: a substrate; an organic dye layer arranged on a side of the substrate; (N-M) inorganic optical layers formed on a side, opposite to the substrate, of the organic dye layer, wherein N>M>0, and N and M are both integers; a light shielding structure formed on a side, opposite to the substrate, of the (N-M) inorganic optical layers, wherein the light shielding structure defines a region for forming a light blocking portion and a region for forming a light transmitting portion on the substrate; and the light shielding structure is configured to absorb light beams with a wavelength range of 400 nm to 700 nm; M inorganic optical layers formed on a side, opposite to the organic dye layer, of the light shielding structure, wherein the M inorganic optical layers cover the (N-M) inorganic optical layers and the light shielding structure; wherein the light shielding structure and the M inorganic optical layers covering the light shielding structure together form the light blocking portion, and in the light blocking portion, the M inorganic optical layers are used as an inorganic light shielding structure protective layer; and the light blocking portion has a reflectivity of 1% or less for a light beam with a wavelength range of 500 nm to 775 nm when an incident angle is in a range of 0 to 5 degrees; the filter unit has a target center wavelength, and the optical thickness of the inorganic light shielding structure protective layer is between 65% and 120% of one quarter of the target center wavelength, and the light transmitting portion has a reflectivity of 2% or less for a light beam with a wavelength range of 500 nm to 775 nm when an incident angle is in a range of 0 to 5 degrees; and wherein the substrate located in the light transmitting portion is not covered by the light shielding structure, and in the light transmitting portion, the (N-M) inorganic optical layers and the M inorganic optical layers located thereon are used together as an inorganic optical composite layer.

A second aspect provides a filter unit, which includes: a substrate; an organic dye layer arranged on a side of the substrate; an insulating layer formed on a side, opposite to the substrate, of the organic dye layer; a light shielding structure formed on a side, opposite to the organic dye layer, of the insulating layer, wherein the light shielding structure defines a region for forming a light blocking portion and a region for forming a light transmitting portion on the substrate; and the light shielding structure is configured to absorb light beams with a wavelength range of 400 nm to 700 nm; an inorganic optical composite layer formed on a side, opposite to the organic dye layer, of the light shielding structure and covering the light shielding structure, wherein the inorganic optical composite layer includes N inorganic optical layers, wherein N>0, and N is an integer; wherein the light shielding structure and the inorganic optical composite layer covering the light shielding structure together form the light blocking portion, and in the light blocking portion, the inorganic optical composite layer is used as an inorganic light shielding structure protective layer; the light blocking portion has a reflectivity of 1% or less for a light beam with a wavelength range of 500 nm to 775 nm when an incident angle is in a range of 0 to 5 degrees; and wherein the substrate located in the light transmitting portion is not covered by the light shielding structure.

In one embodiment, the filter unit further includes an auxiliary organic dye layer, an auxiliary inorganic optical composite layer and an inorganic protective layer on a side, opposite to the organic dye layer, of the substrate; the thickness of the organic dye layer is not greater than 10 microns, and the thickness of the auxiliary organic dye layer is 20 microns or greater; and the inorganic protective layer covers a top surface of the auxiliary inorganic optical composite layer and an auxiliary inorganic optical composite layer annular side surface, and covers at least a portion of an auxiliary organic dye layer annular side surface.

In one embodiment, a side wall of the filter unit has a step portion, and the step portion is located on a side wall of the auxiliary organic dye layer, or on a side wall of the substrate, or at a junction of the auxiliary organic dye layer and the substrate.

In one embodiment, the filter unit further includes an auxiliary organic dye layer and an auxiliary inorganic optical composite layer on a side, opposite to the organic dye layer, of the substrate; the thickness of the organic dye layer is not greater than 10 microns, and the thickness of the auxiliary organic dye layer is 20 microns or greater; an organic coking structure is formed in at least a portion of an auxiliary organic dye layer annular side surface of the auxiliary organic dye layer, and the organic coking structure is a structure formed after the auxiliary organic dye layer is irradiated by a laser.

In one embodiment, a side wall of the filter unit has a step portion, and the step portion is located on a side wall of the auxiliary organic dye layer, or on a side wall of the substrate, or at a junction of the auxiliary organic dye layer and the substrate.

In one embodiment, an oxygen-carbon ratio of the organic coking structure is 2.46 to 6.92 times an oxygen-carbon ratio of the auxiliary organic dye layer which is not irradiated by a laser.

In one embodiment, the oxygen-carbon ratio of the organic coking structure is 1.18 to 1.66.

In one embodiment, when viewed from a cross-sectional direction, an upper side and a lower side of the filter unit respectively have a first width and a second width, and the first width is less than the second width.

In one embodiment, a difference value between the first width and the second width is 5 to 150 microns.

In one embodiment, the filter unit further includes: an auxiliary organic dye layer formed on a side, opposite to the organic dye layer, of the substrate; an auxiliary insulating layer formed on a side, opposite to the substrate, of the auxiliary organic dye layer and covering the auxiliary organic dye layer; an auxiliary light shielding structure formed on a side, opposite to the substrate, of the auxiliary insulating layer and configured to absorb light beams with a wavelength range of 400 nm to 700 nm; and an auxiliary inorganic light shielding structure protective layer formed on a side, opposite to the substrate, of the auxiliary insulating layer and covering the auxiliary light shielding structure; wherein the auxiliary light shielding structure and the auxiliary inorganic light shielding structure protective layer covering the auxiliary light shielding structure together form an auxiliary light blocking portion; and the auxiliary light blocking portion has a reflectivity of 1% or less for a light beam with a wavelength range of 500 nm to 775 nm when the incident angle is in a range of 0 to 5 degrees.

In one embodiment, when viewed from above, the light shielding structure is aligned with the auxiliary light shielding structure.

In one embodiment, the light blocking portion has a reflectivity of 0.5% or less for a light beam with a wavelength range of 640 nm to 660 nm when the incident angle is in a range of 0 to 5 degrees.

In one embodiment, the light blocking portion has a reflectivity of 0.5% or less for a light beam with a wavelength range of 700 nm to 775 nm when the incident angle is in a range of 0 to 5 degrees.

In one embodiment, two opposite sides of the filter unit are respectively defined as a light incoming side and a light outgoing side, and a side of the filter unit having the light shielding structure is the light incoming side; wherein after a light beam with a wavelength range of 350 nm to 1000 nm enters the light transmitting portion of the filter unit from the light incoming side, a transmittance of the light beam with a wavelength range of 450 nm to 580 nm is 80% or greater, and a transmittance of the light beam with a wavelength range of 750 nm to 1000 nm is 5% or less.

In one embodiment, a transmittance in the insulating layer within a wavelength range of 400 nm to 700 nm is greater than 98%.

In one embodiment, the thickness of the insulating layer is 30 nm or less.

In one embodiment, the filter unit has a target center wavelength, and the optical thickness of the inorganic light shielding structure protective layer is between 65% and 120% of one quarter of the target center wavelength.

A third aspect provides a method for manufacturing a filter unit, which is used for manufacturing a filter unit, and the method for manufacturing a filter unit includes: a basic manufacturing step, including: forming an organic dye layer on a side of a substrate; the method for manufacturing a filter unit further includes the following steps after the basic manufacturing step: a step of forming a first inorganic optical layer: forming (N-M) inorganic optical layers on a side, opposite to the substrate, of the organic dye layer, wherein N>M>0, and N and M are both integers; a step of forming a light shielding structure: forming a light shielding structure on a side, opposite to the substrate, of the (N-M) inorganic optical layers, wherein the light shielding structure defines a region for forming a light blocking portion and a region for forming a light transmitting portion on the substrate; and the light shielding structure is configured to absorb light beams with a wavelength range of 400 nm to 700 nm; and a step of forming a second inorganic optical layer: forming M inorganic optical layers on a side, opposite to the organic dye layer, of the light shielding structure, wherein the M inorganic optical layers cover the (N-M) inorganic optical layers and the light shielding structure; wherein the light shielding structure and the M inorganic optical layers covering the light shielding structure together form the light blocking portion, and in the light blocking portion, the M inorganic optical layers are used as an inorganic light shielding structure protective layer; and the light blocking portion has a reflectivity of 1% or less for a light beam with a wavelength range of 500 nm to 775 nm when an incident angle is in a range of 0 to 5 degrees; the filter unit has a target center wavelength, and the optical thickness of the inorganic light shielding structure protective layer is between 65% and 120% of one quarter of the target center wavelength, and the light transmitting portion has a reflectivity of 2% or less for a light beam with a wavelength range of 500 nm to 775 nm when an incident angle is in a range of 0 to 5 degrees; and wherein the substrate located in the light transmitting portion is not covered by the light shielding structure, and in the light transmitting portion, the (N-M) inorganic optical layers and the M inorganic optical layers located thereon are used together as an inorganic optical composite layer.

A fourth aspect provides a method for manufacturing a filter unit, which is used for manufacturing a filter unit, and the method for manufacturing a filter unit includes: a basic manufacturing step, including: forming an organic dye layer on a side of a substrate; the method for manufacturing a filter unit further includes the following steps after the basic manufacturing step: a step of forming an insulating layer: forming an insulating layer on a side, opposite to the substrate, of the organic dye layer; a step of forming a light shielding structure: forming a light shielding structure on a side, opposite to the organic dye layer, of the insulating layer, wherein the light shielding structure defines a region for forming a light blocking portion and a region for forming a light transmitting portion on the substrate; and the light shielding structure is configured to absorb light beams with a wavelength range of 400 nm to 700 nm; and a step of forming an inorganic optical composite layer: forming an inorganic optical composite layer on a side, opposite to the organic dye layer, of the light shielding structure, wherein the inorganic optical composite layer includes N inorganic optical layers covering the light shielding structure, wherein N>0, and N is an integer; wherein the light shielding structure and the inorganic optical composite layer covering the light shielding structure together form the light blocking portion, and in the light blocking portion, the inorganic optical composite layer is used as an inorganic light shielding structure protective layer; the light blocking portion has a reflectivity of 1% or less for a light beam with a wavelength range of 500 nm to 775 nm when an incident angle is in a range of 0 to 5 degrees; and wherein the substrate located in the light transmitting portion is not covered by the light shielding structure.

In one embodiment, after forming the inorganic light shielding structure protective layer, the method for manufacturing a filter unit further includes at least one cleaning step: cleaning the filter unit; wherein in the at least one cleaning step, the filter unit is cleaned using plasma or chemical detergent.

In one embodiment, the method for manufacturing a filter unit further includes the following steps: a step of forming an auxiliary light shielding structure: forming an auxiliary light shielding structure on a side, opposite to the organic dye layer, of the substrate; wherein the auxiliary light shielding structure is configured to absorb light beams with a wavelength range of 400 nm to 700 nm; a step of forming an auxiliary inorganic light shielding structure protective layer: forming an auxiliary inorganic light shielding structure protective layer on a side, opposite to the substrate, of the auxiliary light shielding structure to cover the auxiliary light shielding structure; wherein the auxiliary light shielding structure and the auxiliary inorganic light shielding structure protective layer covering the auxiliary light shielding structure together form an auxiliary light blocking portion; and the auxiliary light blocking portion has a reflectivity of 1% or less for a light beam with a wavelength range of 500 nm to 775 nm when the incident angle is in a range of 0 to 5 degrees.

In one embodiment, the thickness of the organic dye layer is not greater than 10 microns, and in the method for manufacturing a filter unit, an auxiliary organic dye layer and an auxiliary inorganic optical composite layer are sequentially formed on a side, opposite to the organic dye layer, of the substrate, and the thickness of the auxiliary organic dye layer is 20 microns or greater; in the step of forming a light shielding structure, the formed light shielding structures are a plurality of annular light shielding structures; and the method for manufacturing a filter unit further includes the following steps: a first cutting step: using a first cutting method to cut at least a portion of the auxiliary organic dye layer and the auxiliary inorganic optical composite layer to form a plurality of grooves; a step of forming an inorganic protective layer: forming an inorganic protective layer such that side walls and bottom surfaces forming each of the grooves are covered with the inorganic protective layer; a second cutting step: using a second cutting method to cut along the plurality of grooves to cut off the substrate, the organic dye layer, the inorganic optical composite layer and the inorganic light shielding structure protective layer to form a plurality of filter units; wherein the second cutting method is different from the first cutting method; wherein at least a portion of an auxiliary organic dye layer annular side surface of the auxiliary organic dye layer included in each of the filter units is covered by the inorganic protective layer included in the filter unit; wherein, the basic manufacturing step, the step of forming a light shielding structure and the step of forming an inorganic light shielding structure protective layer are all performed before the second cutting step; the first cutting step is performed between the basic manufacturing step and the second cutting step; and the step of forming an inorganic protective layer is performed between the first cutting step and the second cutting step.

In one embodiment, the thickness of the organic dye layer is not greater than 10 microns, and an auxiliary organic dye layer and an auxiliary inorganic optical composite layer are sequentially formed on a side, opposite to the organic dye layer, of the substrate, and the thickness of the auxiliary organic dye layer is 20 microns or greater; in the step of forming a light shielding structure, the formed light shielding structures are a plurality of annular light shielding structures; and the method for manufacturing a filter unit further includes the following steps: a first cutting step: using a first cutting method to cut at least a portion of the auxiliary organic dye layer and the auxiliary inorganic optical composite layer to form a plurality of grooves; wherein, after the first cutting step, at least a portion of the auxiliary organic dye layer located in the groove is to be formed into an organic coking structure; a second cutting step: using a second cutting method to cut along the plurality of grooves to cut off the substrate, the organic dye layer, the inorganic optical composite layer and the inorganic light shielding structure protective layer to form a plurality of filter units; wherein at least a portion of a peripheral side wall of the auxiliary organic dye layer of each of the filter units corresponds to the organic coking structure; and wherein, the basic manufacturing step, the step of forming a light shielding structure and the step of forming an inorganic light shielding structure protective layer are all performed before the second cutting step; and the first cutting step is performed between the basic manufacturing step and the second cutting step.

In one embodiment, the light shielding structure is formed by a printing method, and the inorganic optical composite layer is formed by a sputtering method.

In one embodiment, in the step of forming an insulating layer, an auxiliary insulating layer is further formed on a side, opposite to the organic dye layer, of the substrate, and the auxiliary insulating layer covers the auxiliary organic dye layer.

In summary, as to the method for manufacturing a filter unit and the filter unit of one embodiment of the present application, through making the inorganic light shielding structure protective layer conform to a specific optical design, the light blocking portion can effectively prevent the light shielding structure from being damaged in subsequent processes such as cleaning, and the light transmitting portion can maintain good optical properties.

For further understanding features and technical contents of the present application, please refer to the following detailed description and the accompanying drawings of the present application, however, these descriptions and the accompanying drawings are merely used to illustrate the present application, rather than limiting the protection scope of the present application in any way.

### BRIEF DESCRIPTION OF THE DRAWINGS

FIG. 1 is a flow diagram of a first embodiment of a method for manufacturing a filter unit of the present application.

FIG. 2 is a cross-sectional schematic diagram of a first embodiment of a filter unit of the present application.

FIG. 3A is a schematic diagram showing a relationship between a wavelength and a reflectivity of a light blocking portion of the filter unit of the present application when an incident angle is 0 degree.

FIG. 3B is a schematic diagram showing the relationship between the wavelength and the reflectivity of the light blocking portion of the filter unit of the present application when the incident angle is 5 degrees.

FIG. 4 is a schematic diagram showing a relationship between a wavelength and a reflectivity of a light transmitting portion of the filter unit of the present application when the incident angle is 0 degree.

FIG. 5 is a flow diagram of a second embodiment of the method for manufacturing a filter unit of the present application.

FIG. 6 is a cross-sectional schematic diagram of a second embodiment of the filter unit of the present application.

FIG. 7 is a flow diagram of a third embodiment of the method for manufacturing a filter unit of the present application.

FIG. 8 is a top view of a product after a step of forming a light shielding structure of the third embodiment of the method for manufacturing a filter unit of the present application.

FIGS. 9 and 10 are respectively a top view and a cross-sectional schematic diagram of a third embodiment of the filter unit of the present application.

FIG. 11 is a flow diagram of a fourth embodiment of the method for manufacturing a filter unit of the present application.

FIG. 12 is a cross-sectional schematic diagram of a product after a step of forming an inorganic protective layer of the fourth embodiment of the method for manufacturing a filter unit of the present application.

FIG. 13 is a cross-sectional schematic diagram of a fourth embodiment of the filter unit of the present application.

FIG. 14 is a flow diagram of a fifth embodiment of the method for manufacturing a filter unit of the present application.

FIG. 15 is a cross-sectional schematic diagram of a product after a first cutting step of the fifth embodiment of the method for manufacturing a filter unit of the present application.

FIG. 16 is a cross-sectional schematic diagram of a fifth embodiment of the filter unit of the present application.

FIG. 17 is a cross-sectional schematic diagram of a sixth embodiment of the filter unit of the present application.

FIG. 18 is a flow diagram of a seventh embodiment of the method for manufacturing a filter unit of the present application.

FIG. 19 is a cross-sectional schematic diagram of a seventh embodiment of the filter unit of the present application.

FIG. 20 is a flow diagram of an eighth embodiment of the method for manufacturing a filter unit of the present application.

FIG. 21 is a cross-sectional schematic diagram of an eighth embodiment of the filter unit of the present application.

FIG. 22 is a flow diagram of a ninth embodiment of the method for manufacturing a filter unit of the present application.

FIG. 23 is a cross-sectional schematic diagram of a ninth embodiment of the filter unit of the present application.

FIG. 24 is a flow diagram of a tenth embodiment of the method for manufacturing a filter unit of the present application.

FIG. 25 is a cross-sectional schematic diagram of a product after a step of forming an auxiliary inorganic protective layer of the tenth embodiment of the method for manufacturing a filter unit of the present application.

FIG. 26 is a cross-sectional schematic diagram of a tenth embodiment of the filter unit of the present application.

FIG. 27 is a flow diagram of an eleventh embodiment of the method for manufacturing a filter unit of the present application.

FIG. 28 is a cross-sectional schematic diagram of a product after a first cutting step of the eleventh embodiment of the method for manufacturing a filter unit of the present application.

FIG. 29 is a cross-sectional schematic diagram of an eleventh embodiment of the filter unit of the present application.

FIG. 30 is a cross-sectional schematic diagram of a twelfth embodiment of the filter unit of the present application.

### DETAILED DESCRIPTION OF THE EMBODIMENTS

In the following description, if it is pointed out that reference is made to a specific drawing or as shown in a specific drawing, it is merely used to emphasize that in subsequent description, most of the mentioned relevant contents appear in the specific drawing, but is not limited to the reference to the specific drawing in the subsequent description.

It should be noted that in order to make the drawings clearer, the drawing of section lines is omitted in each cross-sectional view, and the thickness of each layer in each cross-sectional view and the proportional relationship between them are merely drawn for the convenience of description, rather than limiting the thickness or proportional relationship between the layers contained in the product presented in the cross-sectional view.

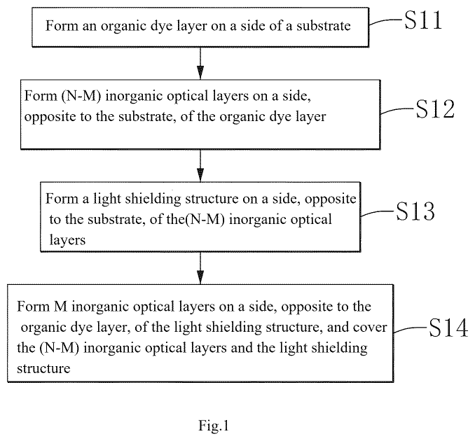

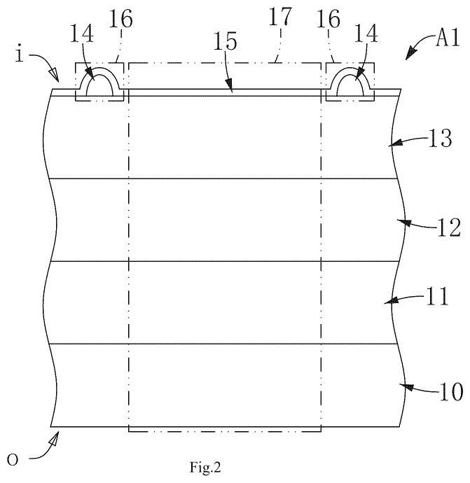

Please refer to FIG. 1 and FIG. 2 which are respectively a flow diagram of a first embodiment of a method for manufacturing a filter unit of the present application and a cross-sectional schematic diagram of a first embodiment of a filter unit of the present application. The method for manufacturing a filter unit of FIG. 1 can be used for manufacturing a first filter unit A1 of FIG. 2. The method for manufacturing the filter unit includes: a basic manufacturing step S11: forming an organic dye layer 12 on a side of a substrate 11; a step of forming a first inorganic optical layer S12: forming (N-M) inorganic optical layers 13 on a side, opposite to the substrate 11, of the organic dye layer 12, wherein N>M>0, and N and M are both integers; a step of forming a light shielding structure S13: forming a light shielding structure 14 on a side, opposite to the substrate 11, of the (N-M) inorganic optical layers 13, wherein the light shielding structure 14 defines a region for forming a light blocking portion 16 and a region for forming a light transmitting portion 17 on the substrate 11; and the light shielding structure 14 is mainly configured to absorb light beams with a wavelength range of 400 nm to 700 nm; and a step of forming a second inorganic optical layer S14: forming M inorganic optical layers on a side, opposite to the organic dye layer 12, of the light shielding structure 14, wherein the M inorganic optical layers cover the (N-M) inorganic optical layers 13 and the light shielding structure 14.

Wherein, the light shielding structure 14 and the M inorganic optical layers covering the light shielding structure 14 together form the light blocking portion 16, and in the light blocking portion 16, the M inorganic optical layers are used as an inorganic light shielding structure protective layer 15; and the light blocking portion 16 has a reflectivity of 1% or less for a light beam with a wavelength range of 500 nm to 775 nm when an incident angle is in a range of 0 to 5 degrees; and the substrate 11 located in the light transmitting portion 17 is not covered by the light shielding structure 14, and in the light transmitting portion 17, the (N-M) inorganic optical layers 13 and the M inorganic optical layers located thereon are used together as an inorganic optical composite layer. In the present embodiment, the above inorganic optical layer can be formed by a sputtering method or other suitable methods. It should be noted that although the (N-M) inorganic optical layers 13 and the inorganic light shielding structure protective layer 15 shown in FIG. 2 are both single layers, this is merely for illustration and is not intended for limitation. In fact, the (auxiliary or balanced) inorganic optical composite layer and the (auxiliary) inorganic light shielding structure protective layer mentioned in the specification can be independently of a single-layer structure or a multi-layer structure.

In a practical application, a balanced inorganic optical composite layer 10 may also be formed on a side, opposite to the (N-M) inorganic optical layers 13, of the substrate 11. The material and thickness of the balanced inorganic optical composite layer 10 may be the same as or similar to those of the (N-M) inorganic optical layers 13. Therefore, the substrate 11 may be effectively prevented from warping caused by different stresses on two sides of the substrate 11 during the manufacturing process, and the yield of the final product can be effectively improved. In an embodiment in which the thickness of the (N-M) inorganic optical layers 13 is relatively small (e.g., less than 1% of the thickness of the substrate 11), the stress on the substrate 11 during the manufacturing process is relatively small, and warpage does not easily occur. Therefore, in such an embodiment, there may be no balanced inorganic optical composite layer 10 on one side of the substrate 11. In other words, in practical applications, whether the balanced inorganic optical composite layer 10 should be arranged may be determined based on whether the substrate 11 is prone to warpage.

As described above, through the design of the inorganic light shielding structure protective layer 15 and the like, the light shielding structure 14 included in the first filter unit A1 finally manufactured will be covered and protected by the inorganic light shielding structure protective layer 15 and will not be easily damaged in the subsequent manufacturing processes.

In practical applications, specific materials respectively included in the substrate 11, the organic dye layer 12 and the inorganic optical composite layer (that is, the inorganic optical composite layer refers to the (N-M) inorganic optical layers 13 and the inorganic light shielding structure protective layer 15 formed by the M inorganic optical layers) included in the first filter unit A1 can be selected according to the product to which the first filter unit A1 is finally applied, and the specific materials are not limited herein. In practical applications, the substrate can be, for example, an organic substrate, an inorganic substrate, or a multi-layer composite substrate (for example, including multiple organic layers and multiple inorganic layers). The substrate 11 serves as the main supporting structure of the first filter unit A1. The organic dye layer 12 absorbs light beams in a specific wavelength range and prevents the light beams from passing through. The inorganic optical composite layer located in the light transmitting portion 17 determines light beams of which specific wavelength ranges can pass through the first filter unit A1.

For example, assuming that the first filter unit A1 is ultimately applied to camera lenses, glasses, front windshields of cars and the like to filter invisible light and allow visible light to pass through, the substrate 11 may be an inorganic substrate such as blue glass, white glass, etc.; the organic dye layer 12 may include a dye that absorbs a specific optical band (an ultraviolet light absorber or an infrared light absorber), an adhesive agent, a leveling agent, etc.; the inorganic optical composite layer located in the light transmitting portion 17 may include a plurality of first refractive layers H and a plurality of second refractive layers L which are stacked in a staggered manner, and the refractive index of any first refractive layer is greater than the refractive index of any second refractive layer, that is, a structure stacked like HLHL . . . HL; the design of the balanced inorganic optical composite layer 10 may be the same as or similar to that of the inorganic optical composite layer located in the light transmitting portion 17, also a structure stacked like HLHL . . . HL, and the material, the number of layers and the film thickness of the balanced inorganic optical composite layer 10 may be the same as or different from those of the inorganic optical composite layer located in the light transmitting portion 17. Regarding the design of the total number of the first refractive layers, the thickness of each first refractive layer, the total number of the second refractive layers, the thickness of each second refractive layer and the like included in the inorganic optical composite layer and the balanced inorganic optical composite layer 10 located in the light transmitting portion 17, the refractive index, a transparent region and the thickness of the organic dye layer 12 should be taken into consideration together and should be incorporated into the spectrum design, and the organic dye layer 12 as a whole is regarded as a third refractive layer N. Therefore, the final film layer is designed as HLHL . . . HLNHLHL . . . HL, and is designed according to the practical application scenario of the first filter unit A1 and the wavelength range of the light beams to be filtered out by the first filter unit A1.

In the embodiment that does not include the balanced inorganic optical composite layer 10, the final film layer is designed as NHLHL . . . HL, and can also be designed according to the practical application scenario of the first filter unit A1 and the wavelength range of the light beams to be filtered out by the first filter unit A1. Specific materials of the first refractive layer and the second refractive layer are not particularly limited as long as the specific materials meet the required optical properties (for example, the refractive index and an extinction coefficient). For example, the first refractive layer and the second refractive layer can respectively include oxides, nitrides, oxynitrides, carbides, other suitable optical coating materials or a combination of the above, specifically, including but not limited to silicon hydride, silicon nitride hydride, silicon dioxide, aluminum oxide, titanium dioxide, niobium pentoxide, tantalum pentoxide, silicon nitride, silicon oxynitride, silicon carbide, magnesium fluoride, zirconium dioxide, etc. In the present embodiment, since the first refractive layer and the second refractive layer can realize special optical properties (for example, the interference effect described below), in the present specification, the first refractive layer and the second refractive layer are referred to as inorganic optical layers.

In practical applications, when the first filter unit A1 is mounted in the application product, after the light beam passes through the first filter unit A1, part of the light beam will be reflected to the side, where the light shielding structure 14 is formed, of the first filter unit A1, while the light shielding structure 14 is just configured to absorb the reflected light beam. For example, when the first filter unit A1 is applied to a camera to filter out invisible light, part of the visible light passing through the first filter unit A1 may be reflected by a photosensitive assembly to the side, where the light shielding structure 14 is formed, of the first filter unit A1. In this application scenario, if no light shielding structure 14 is arranged on the first filter unit A1, then the light beam reflected by the photosensitive assembly may enter a photosensitive region of the photosensitive assembly, thereby eventually leading to ghosting in a photo; that is, by arranging the light shielding structure 14, the ghosting in the photo can be effectively reduced.

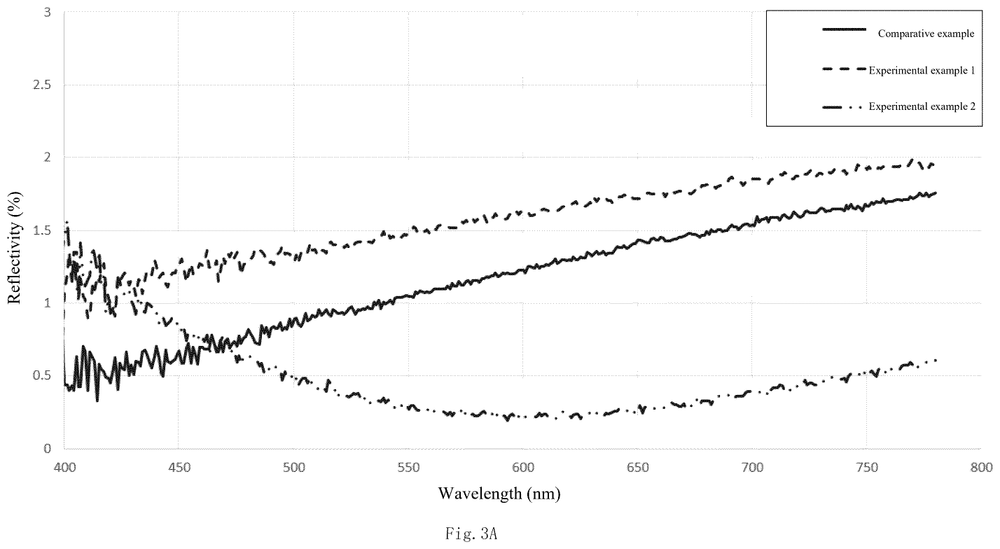

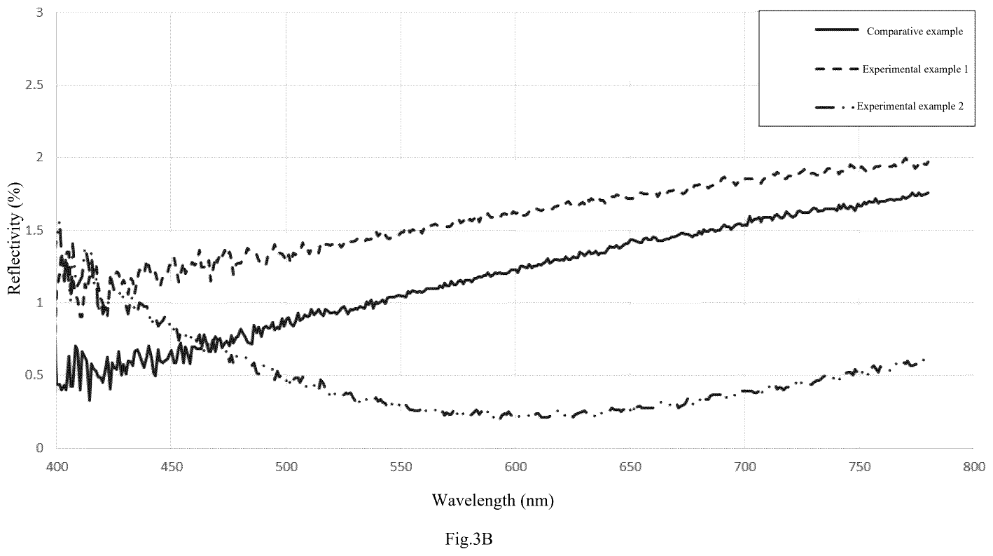

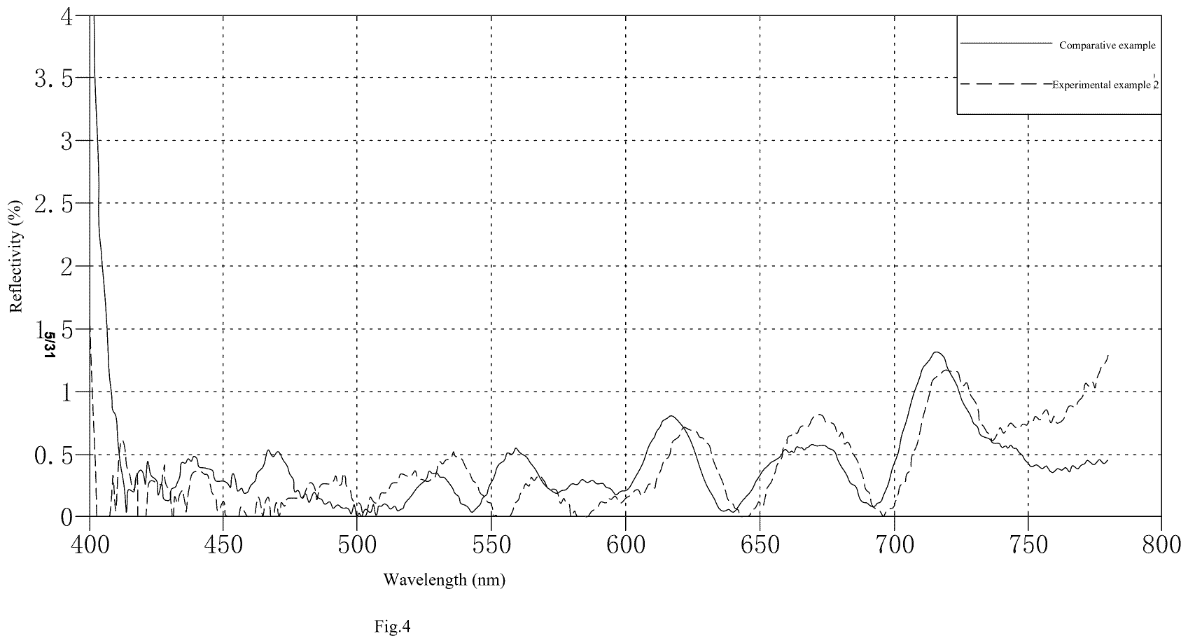

In practical applications, especially in an embodiment in which the first filter unit A1 is applied to a camera, the light blocking portion 16 has a reflectivity of 1% or less for a light beam with a wavelength range of 500 nm to 775 nm when the incident angle is in a range of 0 to 5 degrees. Through such a design, the first filter unit A1 can have better optical properties at the position where the light shielding structure 14 exists. Specifically, referring to FIGS. 3A, 3B and 4, FIG. 3A is a schematic diagram showing a relationship between a wavelength and a reflectivity of the light blocking portion of the filter unit of a comparative example, experimental example 1, and experimental example 2 when the incident angle is 0 degree, FIG. 3B is a schematic diagram showing the relationship between the wavelength and the reflectivity of the light blocking portion of the filter unit of the comparative example, experimental example 1, and experimental example 2 when the incident angle is 5 degrees, and FIG. 4 is a schematic diagram showing a relationship between a wavelength and a reflectivity of the light transmitting portion of the filter unit of the comparative example and experimental example 2 when the incident angle is 0 degree. FIGS. 3 A, 3B and 4 are experimental charts of the filter unit conducted by the inventor using a spectrometer (for example, a spectrometer manufactured by Agilent Technologies, PerkinElmer, and other manufacturers) in the process of inventing the present application. The charts are, for example, generated by software attached to the spectrometer, or the charts can be generated using data output by the spectrometer with software such as Excel, Google Sheets, etc.

FIG. 3A is a graph showing the relationship between the wavelength and the reflectivity of the light beam reflected by the light shielding structure after a test light beam irradiates the light shielding structure of the comparative example, experimental example 1, and experimental example 2 when the incident angle is 0 degree, and FIG. 3B is a graph showing the relationship between the wavelength and reflectivity of the light beam reflected by the light shielding structure after the test light beam irradiates the light shielding structure of the comparative example, experimental example 1, and experimental example 2 when the incident angle is 5 degrees; wherein in the comparative example, the filter unit is not provided with an inorganic light shielding structure protective layer, and the remaining structure of the filter unit is the same as the first filter unit A1 of the present application; the structures in both experimental example 1 and experimental example 2 are the same as those of the first filter unit A1 of the present application, and the difference between experimental example 1 and experimental example 2 mainly lies in the thickness of the inorganic light shielding structure protective layer 15. Specifically, the thickness of the inorganic light shielding structure protective layer 15 of experimental example 1 is 30 nm, and the inorganic light shielding structure protective layer has a reflection condition of constructive interference in a waveband range of 500 nm to 775 nm; the thickness of the inorganic light shielding structure protective layer of experimental example 2 is 88 nm, and the inorganic light shielding structure protective layer has a reflection condition of destructive interference in a waveband range of 500 nm to 775 nm, that is, the filter units of the comparative example, experimental example 1, and experimental example 2 in FIGS. 3A and 3B are only different in the inorganic light shielding structure protective layer. It can be seen from the comparative example and experimental example 1 of FIGS. 3A and 3B that, compared with a filter unit which is not provided with an inorganic light shielding structure protective layer, the light blocking portion of a filter unit provided with an inorganic light shielding structure protective layer on the light shielding structure may have an increased reflectivity for a light beam with a wavelength range of 500 nm to 775 nm when the incident angle is 0 degree and 5 degrees, thereby leading to an adverse effect on the final optical properties of the filter unit.

For example, if the filter unit having the characteristics of experimental example 1 is applied to a camera lens, in this case, the amount of light of a light beam with a wavelength range of 500 nm to 775 nm reflected from the light blocking portion is relatively high, and the reflected light from the light blocking portion interferes with the light of the light transmitting portion (e.g., the light transmitting portion 17 in FIG. 2), thereby leading to glare or ghosting in the captured image. In contrast, it can be known from the comparative example and experimental example 2 of FIGS. 3A and 3B that, compared with the filter unit not provided with an inorganic light shielding structure protective layer, the light blocking portion of the filter unit provided with an inorganic light shielding structure protective layer of a specific thickness on the light shielding structure has a decreased reflectivity for a light beam with a wavelength range of 500 nm to 775 nm when the incident angle is 0 degree and 5 degrees. Therefore, through the filter unit and the method for manufacturing the filtering unit in the present embodiment, the light blocking portion 16 has a reflectivity of 1% or less for a light beam with a wavelength range of 500 nm to 775 nm when the incident angle is in a range of 0 to 5 degrees. Through such a design, not only the light shielding structure 14 can be protected by the inorganic light shielding structure protective layer 15, but also adverse effects on the final optical properties of the first filter unit A1 can be avoided, such that the first filter unit A1 has better optical properties.

FIG. 4 shows the relationship between the wavelength and the reflectivity of the light beam reflected by the light transmitting portion after the test light beam irradiates the light transmitting portion of the comparative example and experimental example 2 when the incident angle is 0 degree; wherein in the comparative example, the filter unit is not provided with an inorganic light shielding structure protective layer, and the remaining structure of the filter unit is the same as the first filter unit A1 of the present application; experimental example 2 involves the first filter unit A1 of the present application, and the filter unit is provided with an inorganic light shielding structure protective layer, specifically, the thickness of the inorganic light shielding structure protective layer is 88 nm, and the inorganic light shielding structure protective layer has a reflection condition of destructive interference in a waveband range of 500 nm to 775 nm. It can be clearly known from the comparative example and experimental example 2 of FIG. 4 that, compared with the light transmitting portion not provided with the inorganic light shielding structure protective layer, after a specific inorganic light shielding structure protective layer is formed on the light transmitting portion (i.e., the inorganic light shielding structure protective layer has a reflection condition of destructive interference in a waveband range of 500 nm to 775 nm), when the incident angle is 0 degree, for the reflectivity of a light beam with a wavelength range of 500 nm to 775 nm, the two line segments are similar and the reflectivity is not increased significantly. Therefore, arranging the inorganic light shielding structure protective layer has a very little effect on the final optical properties of the light transmitting portion of the filter unit. Therefore, as to the filter unit of the present embodiment, through arranging the inorganic light shielding structure protective layer, the optical properties of the light blocking portion can be improved without affecting the optical properties of the light transmitting portion.

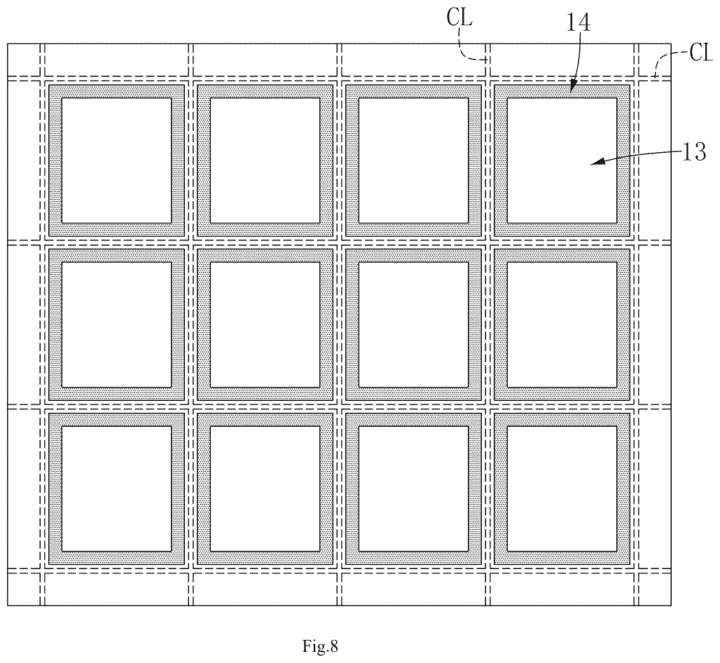

In practical applications, the shape, thickness and size of the light shielding structure 14 can all be designed according to requirements and are not limited herein. In one embodiment, when viewed from above (below), the light shielding structure 14 can be approximately annular, such that the portion of the first filter unit A1 surrounded by the light shielding structure 14 corresponds to the light transmitting portion 17. The light transmitting portion 17 refers to a region of the filter unit allowing the light beam to pass through. Therefore, the specific shape, size and the like of the light transmitting portion 17 can all be changed according to actual requirements. In the present embodiment, as shown in FIG. 8, in a top view of the first filter unit A1, the light transmitting portion 17 can be approximately rectangular, but is not limited thereto. In practical applications, the shapes of the light transmitting portion 17 and a corresponding light shielding structure 14 thereof can be determined according to practical applications and requirements. For example, in the top view of the filter unit A, the shape of the light transmitting portion 17 being surrounded by the light shielding structure 14 can include but is not limited to a circle, an ellipse, a semicircle, a triangle, a square, a polygon, an irregular shape, etc.

In an embodiment in which the material of the inorganic light shielding structure protective layer 15 is approximately the same as the material of one of the (N-M) inorganic optical layers 13, those skilled in the art can adjust the reflectivity of the light blocking portion 16 for a light beam with a wavelength range of 500 nm to 775 nm when the incident angle is in a range of 0 to 5 degrees by, for example, changing the thickness of the inorganic light shielding structure protective layer 15. The design principle of the light blocking portion 16 having a reflectivity of 1% or less for a light beam with a wavelength range of 500 nm to 775 nm when the incident angle is in a range of 0 to 5 degrees is described in more details herein. When light is emitted from air to the inorganic light shielding structure protective layer 15, an interface between the air and the inorganic light shielding structure protective layer 15 will generate first reflected light, and a first reflectivity of the first reflected light is 4.2% to 4.3%. On the other hand, the light entering the inorganic light shielding structure protective layer 15 and reflected from the other side of the inorganic light shielding structure protective layer 15 (i.e., the side in contact with the light shielding structure 14 or the (N-M) inorganic optical layers 13) is second reflected light. After the second reflected light passes through the interface between the inorganic light shielding structure protective layer 15 and the air and enters the air, the second reflected light will interfere with the above first reflected light. If the interference is constructive interference, then an overall reflectivity of the inorganic light shielding structure protective layer 15 will be greater than the above first reflectivity.

On the contrary, if the interference is destructive interference, then the overall reflectivity of the inorganic light shielding structure protective layer 15 will be less than the above first reflectivity. In other words, by designing the material, thickness and number of layers of the inorganic light shielding structure protective layer 15, the overall reflectivity of the inorganic light shielding structure protective layer 15 for a light beam with a wavelength range of 500 nm to 775 nm can be controlled to be 1% or less when the incident angle is in a range of 0 to 5 degrees. On the other hand, since the light transmitting portion 17 is not covered by the light shielding structure 14, the intensity of the second reflected light in the light transmitting portion 17 may be higher than the intensity of the second reflected light in the light blocking portion 16. In some embodiments, the light transmitting portion 17 has an overall reflectivity of less than 2% for a light beam with a wavelength range of 500 nm to 775 nm when the incident angle is in a range of 0 to 5 degrees.

How to design the inorganic light shielding structure protective layer 15 is described in more details with examples. When the optical thickness N*d value (N is the refractive index of the inorganic light shielding structure protective layer, and d is the thickness of the inorganic light shielding structure protective layer) of the inorganic light shielding structure protective layer 15 is designed to be 65% to 120% of one quarter of the target center wavelength, the reflectivity in a range of wavelengths near the target center wavelength can reach a lowest limit value (for example, less than 1%, 0.8%, 0.5% or 0.3%). For example, when the reflectivity of a light beam with a wavelength range of 500 nm to 775 nm is to be minimized, if silicon dioxide (N=1.46) is used as a material of a single inorganic light shielding structure protective layer 15, the target center wavelength can be set to 600 nm. According to the above settings, the optical thickness (N*d value) of the inorganic light shielding structure protective layer 15 can be designed to be 65% to 120% of one quarter of the target center wavelength, that is, between 97.5 nm and 180 nm, while the thickness of the inorganic light shielding structure protective layer 15 can be designed to be (97.5 nm/1.46) to (180 nm/1.46), that is, between 67 nm and 123 nm. Referring to FIGS. 3A and 3B again, experimental example 1 is an embodiment in which silicon dioxide is used as the inorganic light shielding structure protective layer 15 with a thickness of 30 nm, and experimental example 2 is an embodiment in which silicon dioxide is used as the inorganic light shielding structure protective layer 15 with a thickness of 88 nm. When the incident angle is 0 degree and 5 degrees, the reflectivity of the light beams with a wavelength range of 500 nm to 775 nm is less than 1% in both cases, and the reflectivity of the light beams with a wavelength range of 500 nm to 730 nm is less than 0.5% in both cases. In contrast, the light transmitting portion not provided with the inorganic light shielding structure protective layer 15 has a reflectivity of greater than 1% for light beams with a wavelength of 550 nm or greater in both cases when the incident angle is 0 degree and 5 degrees (comparative example). Therefore, it proves that according to the above design principles, the protection of the light shielding structure 14 and the optical properties of the filter unit can be both taken into account. In addition, when the inorganic light shielding structure protective layer 15 is a multi-layer structure, the overall optical thickness (N*d value) of the inorganic light shielding structure protective layer 15 can also be designed to be 65% to 120% of one quarter of the target center wavelength according to the above design principles. In this way, the overall reflectivity of the inorganic light shielding structure protective layer 15 for a light beam with a wavelength range of 500 nm to 775 nm can be controlled to be 1% or less when the incident angle is in a range of 0 to 5 degrees.

According to the above design principles, the overall optical thickness (N*d value) of the inorganic light shielding structure protective layer 15 can be set according to actual requirements, such that the light blocking portion 16 reaches the minimum reflectivity near the predetermined target center wavelength. Therefore, in a wavelength range of 500 nm to 775 nm, the light blocking portion 16 can have a reflectivity of 0.5% or less in a smaller wavelength range. In one of the embodiments, the light blocking portion 16 has a reflectivity of 0.5% or less for a light beam with a wavelength range of 640 nm to 660 nm when the incident angle is in a range of 0 to 5 degrees. In one of the embodiments, the light blocking portion 16 has a reflectivity of 0.5% or less for a light beam with a wavelength range of 540 nm to 560 nm when the incident angle is in a range of 0 to 5 degrees. In one of the embodiments, the light blocking portion 16 has a reflectivity of 0.5% or less for a near-infrared light beam with a wavelength range of 700 nm to 775 nm when the incident angle is in a range of 0 to 5 degrees, thereby further reducing the occurrence of glare or ghosting.

The inorganic light shielding structure protective layer 15 covers the light shielding structure 14 and protects the light shielding structure 14 from being exposed. Therefore, during the cleaning or post-processing process of the first filter unit A1, the light shielding structure 14 will not be easily damaged, such that it can be guaranteed that the light shielding structure 14 can function normally after the first filter unit A1 is manufactured. In one of the specific embodiments, when the inorganic light shielding structure protective layer 15 is of a single-layer structure, the inorganic light shielding structure protective layer 15 can be composed of a material with a low refractive index (for example, silicon dioxide, aluminum oxide (Al₂O₃), magnesium fluoride or zirconium dioxide, etc.), but the material is not limited thereto. In some other specific embodiments, when the inorganic light shielding structure protective layer 15 is of a multi-layer structure, the inorganic light shielding structure protective layer 15 can be the topmost multiple layers in the inorganic optical composite layer, that is, the inorganic light shielding structure protective layer 15 can be a structure stacked like HLHL . . . HL as described above, and the materials that can be used for the inorganic light shielding structure protective layer 15 can be the same as the materials that can be used for the (N-M) inorganic optical layers 13 described above, which will not be repeated herein.

It should be noted that the first filter unit A1 shown in FIG. 2 can be manufactured using the method for manufacturing the filter unit of the above first embodiment, but is not limited thereto. In practice, the first filter unit A1 can be directly applied to a specific product, or the first filter unit A1 can also be manufactured into an article that can be installed in a specific product through relevant processing steps according to requirements. Please refer to the above description for detailed descriptions concerning the substrate 11, the organic dye layer 12, the (N-M) inorganic optical layers 13, the balanced inorganic optical composite layer 10, the light shielding structure 14 and the inorganic light shielding structure protective layer 15 included in the first filter unit A1 of the present embodiment, which will not be repeated herein.

As shown in FIG. 2, in a practical application of the present embodiment, two opposite sides of the first filter unit A1 are respectively defined as a light incoming side i and a light outgoing side o, and a side of the first filter unit A1 having the light shielding structure 14 is the light incoming side o; wherein, after a light beam with a wavelength range of 350 nm to 1000 nm enters the light transmitting portion 17 of the first filter unit A1 from the light incoming side i, a transmittance of the light beam with a wavelength range of 450 nm to 580 nm is 80% or greater, and a transmittance of the light beam with a wavelength range of 750 nm to 1000 nm is 5% or less. In practice, those skilled in the art can refer to the above design principles, and modify, for example, the thickness of the organic dye layer 12 and its main material, the number of inorganic optical layers with different refractive indices included in the inorganic optical composite layer (and/or the balanced inorganic optical composite layer 10), the thickness of each layer, and the refractive index of each layer, such that the light transmitting portion 17 of the first filter unit A1 can achieve the effect of filtering light beams of specific wavelengths.

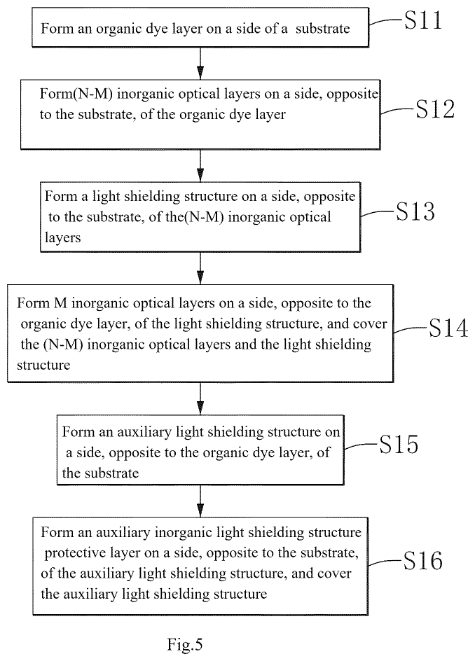

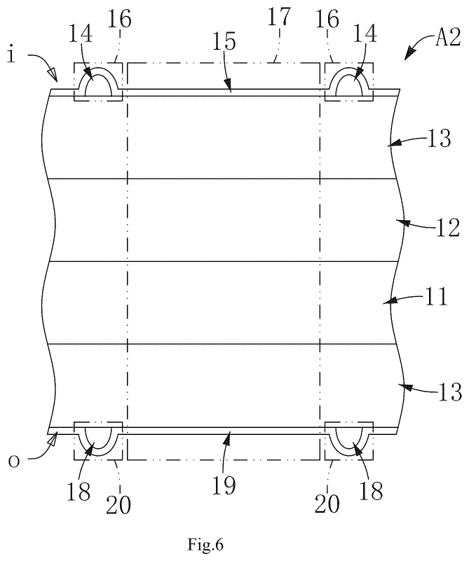

Please refer to FIG. 5 and FIG. 6 which are respectively a flow diagram of a second embodiment of the method for manufacturing a filter unit of the present application and a cross-sectional schematic diagram of a second embodiment of the filter unit using the present application. In the present specification, components marked with the same component symbols in different figures represent that the materials and forming methods that can be used for these components are the same, and the description of these components that appear repeatedly will be omitted as appropriate. For example, the components marked with the same component symbol 14 in FIG. 2 and FIG. 6 (and all subsequent figures) are all light shielding structures, and the description of the material and forming method of the light shielding structure 14 will be omitted when mentioned for the second time. It should be understood that in some applications, the specific material and forming method of the light shielding structure 14 of the second embodiment can be the same as those of the light shielding structure 14 of the first embodiment. However, this is not limited thereto. In some other applications, the specific material and forming method of the light shielding structure 14 of the second embodiment can be different from those of the light shielding structure 14 of the first embodiment.

Please refer to the above description for the similarities between the present embodiment and the first embodiment, which will not be repeated herein. The difference between the present embodiment and the first embodiment lies in that the method for manufacturing a filter unit further includes the following steps: a step of forming an auxiliary light shielding structure S15: forming an auxiliary light shielding structure 18 on a side, opposite to the organic dye layer 12, of the substrate 11, wherein the auxiliary light shielding structure 18 is configured to absorb the light beam with a wavelength range of 400 nm to 700 nm; a step of forming an auxiliary inorganic light shielding structure protective layer S16: forming an auxiliary inorganic light shielding structure protective layer 19 on the side, opposite to the substrate 11, of the auxiliary light shielding structure 18 to cover the auxiliary light shielding structure 18; wherein the auxiliary light shielding structure 18 and the auxiliary inorganic light shielding structure protective layer 19 covering the auxiliary light shielding structure 18 together form an auxiliary light blocking portion 20; and the auxiliary light blocking portion 20 has a reflectivity of 1% or less for a light beam with a wavelength range of 500 nm to 775 nm when the incident angle is in a range of 0 to 5 degrees. It should be noted that the auxiliary light shielding structure 18 and the auxiliary inorganic light shielding structure protective layer 19 basically have the same functions as the light shielding structure 14 and the inorganic light shielding structure protective layer 15, such that materials that can be selected and forming methods thereof are also the same as those of the light shielding structure 14 and the inorganic light shielding structure protective layer 15.

In the present embodiment, firstly, the (N-M) inorganic optical layers 13 are formed on a side, opposite to the organic dye layer 12, of the substrate 11, and then in the step of forming an auxiliary inorganic light shielding structure protective layer S16, M inorganic optical layers are formed on a side, opposite to the (N-M) inorganic optical layers 13, of the auxiliary light shielding structure 18, to serve as the auxiliary inorganic light shielding structure protective layer 19; wherein N>M>0, and N and M are both integers. In this way, the (N-M) inorganic optical layers 13 and the auxiliary inorganic light shielding structure protective layer 19 are similar to the inorganic optical composite layer of the first embodiment.

In practical applications, after the basic manufacturing step S11, the execution order of the step of forming a light shielding structure S13, the step of forming a second inorganic optical layer S14, the step of forming an auxiliary light shielding structure S15 and the step of forming an auxiliary inorganic light shielding structure protective layer S16 can be designed according to requirements. Of course, the step of forming a second inorganic optical layer S14 must be performed after the step of forming a light shielding structure S13, and the step of forming an auxiliary inorganic light shielding structure protective layer S16 must be performed after the step of forming an auxiliary light shielding structure S15. For example, in one embodiment, after the basic manufacturing step S11, the step of forming a light shielding structure S13, the step of forming an auxiliary light shielding structure S15, the step of forming a second inorganic optical layer S14 and the step of forming an auxiliary inorganic light shielding structure protective layer S16 can be performed in sequence; in other embodiments, after the basic manufacturing step S11, the step of forming a light shielding structure S13, the step of forming a second inorganic optical layer S14, the step of forming an auxiliary light shielding structure S15 and the step of forming an auxiliary inorganic light shielding structure protective layer S16 can be performed in sequence. Alternatively, in other embodiments, after the basic manufacturing step S11, the step of forming a light shielding structure S13 and the step of forming an auxiliary light shielding structure S15 can be performed simultaneously first, and then the step of forming a second inorganic optical layer S14 and the step of forming an auxiliary inorganic light shielding structure protective layer S16 can be performed simultaneously.

As shown in FIG. 6, a second filter unit A2 can be manufactured by the method for manufacturing a filter unit of the present embodiment, but is not limited thereto. The main difference between the present embodiment and the above embodiment lies in that the second filter unit A2 further includes an auxiliary light shielding structure 18 and the above auxiliary inorganic light shielding structure protective layer 19. In a practical application of the present embodiment, two opposite sides of the second filter unit A2 are respectively defined as a light incoming side i and a light outgoing side o, and a side of the second filter unit A2 having the light shielding structure 14 is the light incoming side i; wherein, after a light beam with a wavelength range of 350 nm to 1000 nm enters the light transmitting portion 17 of the second filter unit A2 from the light incoming side i, a transmittance of the light beam with a wavelength range of 450 nm to 580 nm is 80% or greater, and a transmittance of the light beam with a wavelength range of 750 nm to 1000 nm is 5% or less. In practical applications, those skilled in the art can refer to the above design principles and modify, for example, the thickness of the organic dye layer 12 and its main material, the number of inorganic optical layers with different refractive indices included in the inorganic optical composite layer (and/or the balanced inorganic optical composite layer 10), the thickness of each layer and the refractive index of each layer, such that the light transmitting portion 17 of the second filter unit A2 can achieve the effect of filtering light beams of a specific wavelength. When viewed from above, the light shielding structure 14 is aligned with the auxiliary light shielding structure 18.

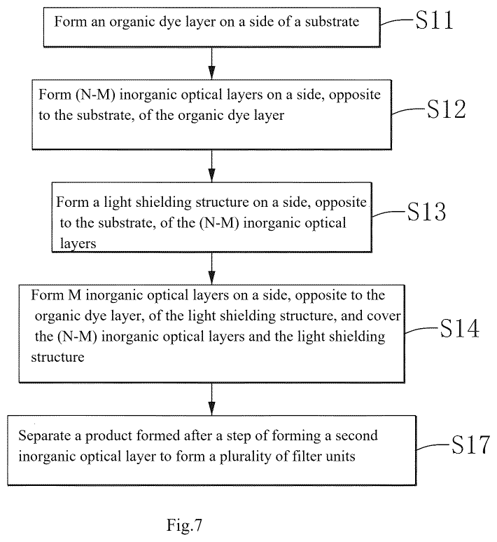

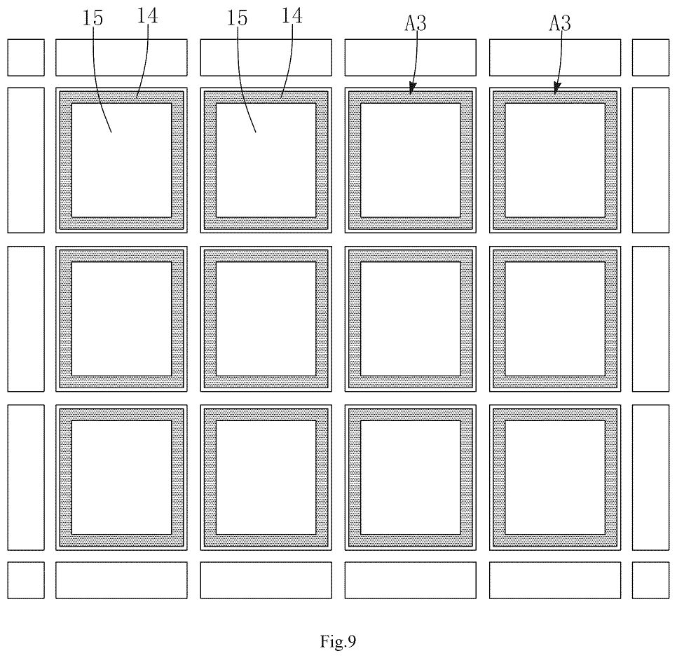

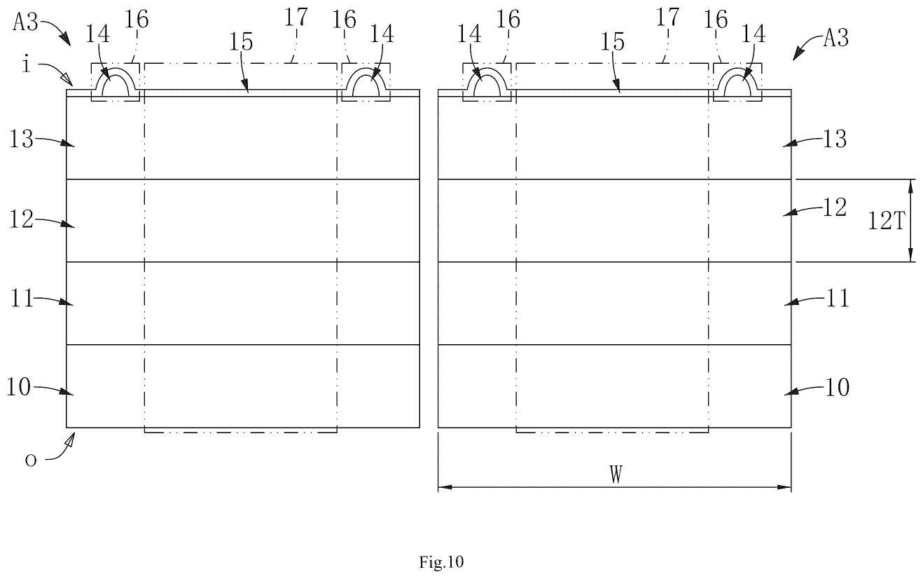

Please refer to FIGS. 7 to 10, FIG. 7 is a flow diagram of a third embodiment of the method for manufacturing a filter unit of the present application. FIG. 8 is a top view of a product after the step of forming a light shielding structure of the method for manufacturing a filter unit of the present embodiment. FIGS. 9 and 10 are respectively a top view and a cross-sectional schematic diagram of a third embodiment of the filter unit.

Please refer to the above description for the similarities between the present embodiment and the first embodiment, which will not be repeated herein. The difference between the present embodiment and the first embodiment lies in that the method for manufacturing a filter unit further includes a separation step S17. It should be particularly noted that in the first to third embodiments, the basic manufacturing step S11, the step of forming a first inorganic optical layer S12, the step of forming a light shielding structure S13 and the step of forming a second inorganic optical layer S14 are all performed on a large-sized substrate 11. Therefore, as shown in FIG. 8, in the step of forming a light shielding structure S13, a plurality of annular light shielding structures 14 which are not connected to each other are formed on the side, opposite to the organic dye layer, of the inorganic optical composite layer, and a distance slightly greater than the width of a cutting line CL is reserved between every two light shielding structures 14. As shown in FIG. 8 to FIG. 10, in the separation step S17, a product formed after the step of forming a second inorganic optical layer S14 is separated to form a plurality of third filter units A3. In an embodiment in which the thickness 12T of the organic dye layer is not greater than 10 microns, in the separation step S17, a laser or a cutter may be used, or a stealth laser wafer dicing technology may be used in combination with a wafer expansion process to perform separation at one time to form a plurality of filter units. In practical applications, if a laser or a cutter is used to cut at one time to form a plurality of filter units in the separation step S17, the width of any section of each filter unit will be approximately equal.

It should be noted that when the thickness 12T of the organic dye layer is not greater than 10 microns, the tearing marks left on the edge of the organic dye layer due to the above wafer expansion process are tolerable and have a little influence on the yield of the product. Therefore, in the one-stage separation step adopted in the present embodiment, the process time can be shortened and then the production efficiency of the product is improved. As shown in FIG. 10, since a one-time/one-stage separation method is adopted, when observed from the cross-sectional direction, the widths of upper and lower sides of the third filter unit A3 are substantially the same, and side walls of the third filter unit A3 are approximately straight. In a practical application of the present embodiment, two opposite sides of the third filter unit A3 are respectively defined as a light incoming side i and a light outgoing side o, and a side of the third filter unit A3 having the light shielding structure 14 is the light incoming side i; wherein, after a light beam with a wavelength range of 350 nm to 1000 nm enters the light transmitting portion 17 of the third filter unit A3 from the light incoming side i, the transmittance of the light beam with a wavelength range of 450 nm to 580 nm is 80% or greater, and the transmittance of the light beam with a wavelength range of 750 nm to 1000 nm is 5% or less. In practical applications, those skilled in the art can refer to the above design principles, and modify, for example, the thickness of the organic dye layer 12 and its main material, the number of inorganic optical layers with different refractive indices included in the inorganic optical composite layer (and/or the balanced inorganic optical composite layer 10), the thickness of each layer, and the refractive index of each layer, such that the light transmitting portion 17 of the third filter unit A3 can achieve the effect of filtering light beams of a specific wavelength.

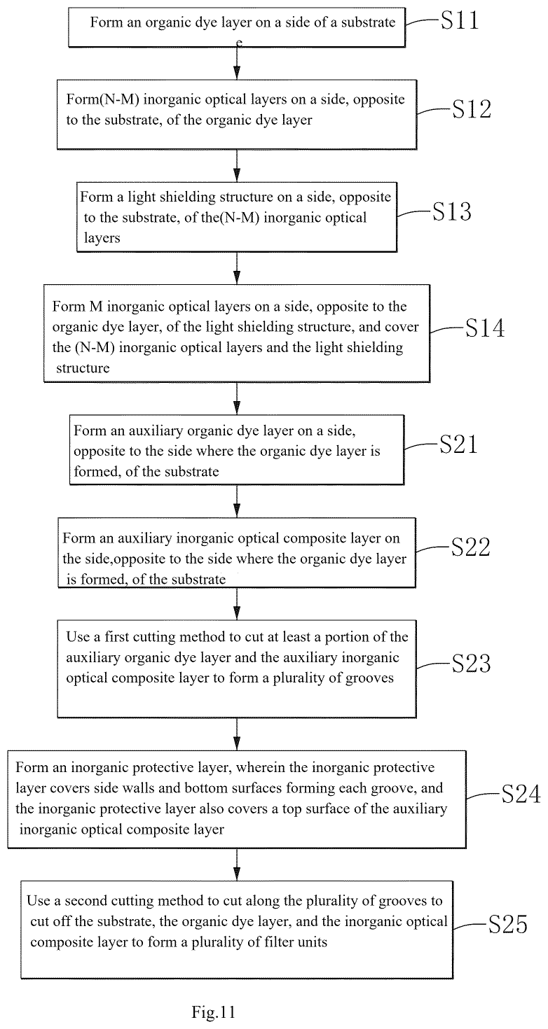

Please refer to FIGS. 11 to 13 which are respectively a flow diagram of a fourth embodiment of the method for manufacturing a filter unit of the present application, a cross-sectional schematic diagram of a product after the step of forming an inorganic protective layer of the present embodiment, and a cross-sectional schematic diagram of a fourth embodiment of the filter unit.

Please refer to the above description for the similarities between the present embodiment and the first embodiment, which will not be repeated herein. The difference between the present embodiment and the first embodiment lies in that the method for manufacturing a filter unit further includes a step of forming an auxiliary organic dye layer S21, a step of forming an auxiliary inorganic optical composite layer S22, a first cutting step S23, a step of forming an inorganic protective layer S24 and a second cutting step S25. It should be noted that the method for manufacturing a filter unit of the present embodiment is particularly suitable for the case in which the thickness 12T of the organic dye layer is smaller (for example, not greater than 10 microns) and the thickness 21T of the auxiliary organic dye layer is greater (for example, 20 microns or greater). Specifically, when the thickness 21T of the auxiliary organic dye layer is 20 microns or greater and less than 140 microns, the first cutting step S23, the step of forming an inorganic protective layer S24 and the second cutting step S25 included in the present embodiment are adopted to form a plurality of fourth filter units A4, and the fourth filter units A4 with relatively good quality will be obtained.

In the step of forming an auxiliary organic dye layer S21 and the step of forming an auxiliary inorganic optical composite layer S22, an auxiliary organic dye layer 21 and an auxiliary inorganic optical composite layer 22 are respectively formed on a side, opposite to the side where the organic dye layer 12 is formed, of the substrate 11. The auxiliary organic dye layer 21 is located between the auxiliary inorganic optical composite layer 22 and the substrate 11. The substrate 11, the organic dye layer 12, the inorganic optical composite layer, the auxiliary organic dye layer 21 and the auxiliary inorganic optical composite layer 22 are structures configured to determine light beams of which wavebands can be filtered out by the fourth filter unit A4. In a practical application of the present embodiment, two opposite sides of the fourth filter unit A4 are respectively defined as a light incoming side i and a light outgoing side o, and a side of the fourth filter unit A4 having the light shielding structure 14 is the light incoming side i; wherein after a light beam with a wavelength range of 350 nm to 1000 nm enters the light transmitting portion 17 of the fourth filter unit A4 from the light incoming side i, the transmittance of the light beam with a wavelength range of 450 nm to 580 nm is 80% or greater, and the transmittance of the light beam with a wavelength range of 750 nm to 1000 nm is 5% or less.

In practical applications, those skilled in the art can refer to the above design principles and determine the thickness of the substrate 11, the organic dye layer 12, the inorganic optical composite layer, the auxiliary organic dye layer 21 and the auxiliary inorganic optical composite layer 22 and their main constituent materials according to the filtering requirements of the fourth filter unit A4. In some embodiments, the main constituent material of the auxiliary inorganic optical composite layer 22 can be approximately the same as that of the inorganic optical composite layer, while the main constituent material of the auxiliary organic dye layer 21 is different from that of the organic dye layer 12. In some other embodiments, the main constituent materials of the auxiliary organic dye layer 21 and the auxiliary inorganic optical composite layer 22 can be approximately the same as those of the organic dye layer 12 and the inorganic optical composite layer, but are not limited thereto. The light shielding structure 14 formed in the present embodiment is an annular light shielding structure (similar to FIG. 8).

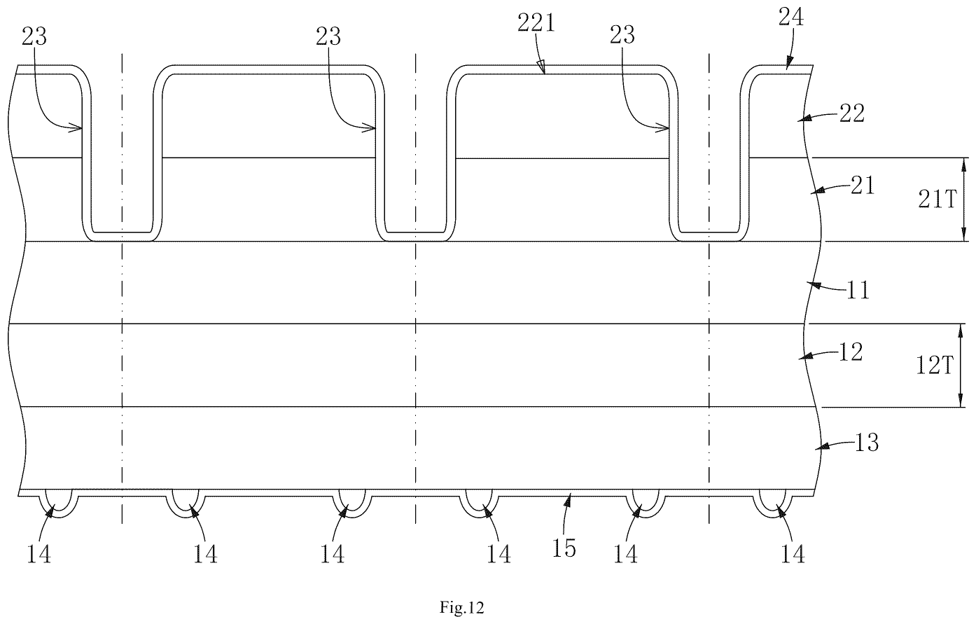

The first cutting step S23 is as follows: using a first cutting method to cut at least a portion of the auxiliary organic dye layer 21 and the auxiliary inorganic optical composite layer 22 to form a plurality of grooves 23. The depth of the groove 23 is not limited to FIG. 12, as long as the depth of the groove 23 is greater than the sum of 65% of the thickness of the auxiliary organic dye layer 21 and the thickness of the auxiliary inorganic optical composite layer 22, the depth falls within the practical applicable range of the groove 23 of the present embodiment. The step of forming an inorganic protective layer S24 is as follows: forming an inorganic protective layer 24 such that the inorganic protective layer 24 covers side walls and bottom surfaces of each groove 23, and the inorganic protective layer 24 also covers a top surface 221 of the auxiliary inorganic optical composite layer 22. The second cutting step S25 is as follows: using a second cutting method to cut along the plurality of grooves 23 to cut off the substrate 11, the organic dye layer 12, and the inorganic optical composite layer (and the auxiliary organic dye layer 21) to form a plurality of fourth filter units A4. Wherein, the second cutting method is different from the first cutting method.

In practice, in the first cutting step S23, for example, at least a portion of the auxiliary organic dye layer 21 and the auxiliary inorganic optical composite layer 22 may be cut along the cutting line CL shown in FIG. 8 to form a plurality of grooves 23 (as shown in FIG. 12). Afterwards, in the second cutting step S25, the second cutting method is used to cut approximately along the cutting line CL (as shown in FIG. 8) to completely cut off the substrate 11, the organic dye layer 12, and the inorganic optical composite layer (and the auxiliary organic dye layer 21) to form a plurality of independent fourth filter units A4. In the first cutting method, a cutter (e.g., a diamond cutter) or a laser (e.g., a laser with a wavelength of 532 nm) may be used to cut, but is not limited thereto; and in the second cutting method, a stealth laser wafer dicing technology may be used in combination with a wafer expansion process to form a plurality of independent filter units.

The basic manufacturing step S11, the step of forming a light shielding structure S13 and the step of forming a second inorganic optical layer S14 are all performed before the second cutting step S25; the first cutting step S23 is performed between the basic manufacturing step S11 and the second cutting step S25; and the step of forming an inorganic protective layer S24 is performed between the first cutting step S23 and the second cutting step S25.

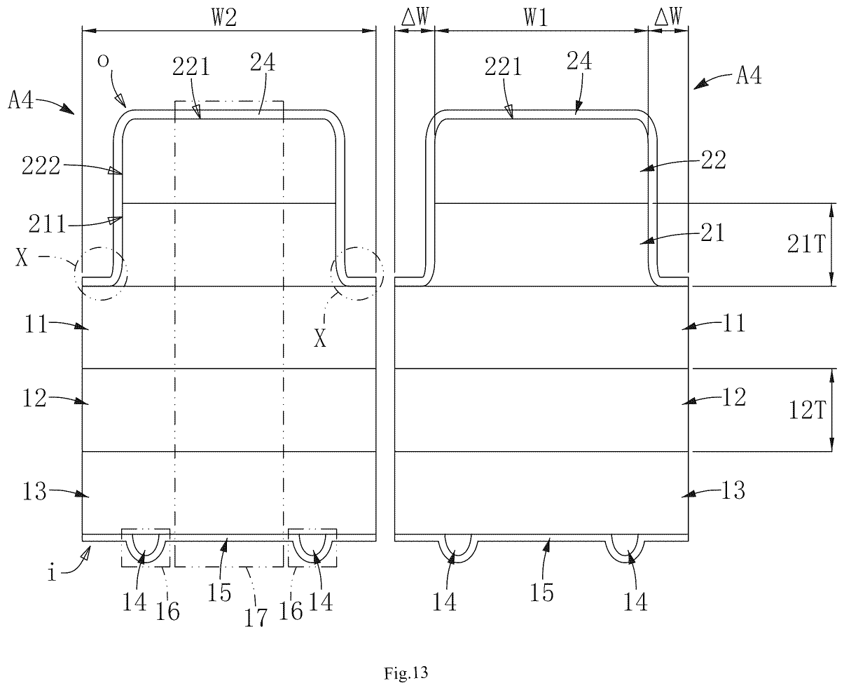

As shown in FIG. 13, the difference between the fourth filter unit A4 of the present embodiment and the first filter unit A1 of the first embodiment (as shown in FIG. 2) lies in that the fourth filter unit A4 of the present embodiment further includes an auxiliary organic dye layer 21, an auxiliary inorganic optical composite layer 22 and an inorganic protective layer 24, the inorganic protective layer 24 covers at least a portion of an auxiliary organic dye layer annular side surface 211, and covers the top surface 221 of the auxiliary inorganic optical composite layer 22 and an auxiliary inorganic optical composite layer annular side surface 222. In the specific application of the present embodiment, the thickness 12T of the organic dye layer is not greater than 10 microns, and the thickness 21T of the auxiliary organic dye layer is 20 microns or greater.

The inorganic protective layer 24 is mainly configured to protect the auxiliary organic dye layer annular side surface 211, such that the auxiliary organic dye layer annular side surface 211 is not prone to be damaged during the subsequent processing processes. In a desired application, the auxiliary organic dye layer annular side surface 211 can be completely covered by the inorganic protective layer 24, but is not limited thereto; in different embodiments, it can also be that in the cross-sectional view of the fourth filter unit A4, 65% or greater of the thickness of the auxiliary organic dye layer annular side surface 211 is covered by the inorganic protective layer 24.

In a specific application, the main material of the inorganic protective layer 24 can be a coating layer with a low refractive index, such as silicon dioxide, aluminum oxide, magnesium fluoride or zirconium dioxide. In an embodiment in which the auxiliary inorganic optical composite layer 22 includes a plurality of first refractive layers and a plurality of second refractive layers, the main material of the inorganic protective layer 24 can be, for example, the same as or approximately the same as the main material of one of the first refractive layers or the main material of one of the second refractive layers.

The method for manufacturing a filter unit of the present embodiment includes a first cutting step, a second cutting step, and a step of forming an inorganic protective layer, such that the auxiliary organic dye layer annular side surface included in each filter unit formed finally can be covered by the inorganic protective layer. Through such a design, the risk of the auxiliary organic dye layer being destroyed or damaged in the subsequent processing processes (such as a high temperature and high pressure environmental testing process) can be effectively reduced.

As shown in FIG. 13, when viewed from the cross-sectional direction, upper and lower sides of the fourth filter unit A4 respectively have a first width W1 and a second width W2, and W1 is less than W2; in addition, each of two side walls of the fourth filter unit A4 has a step portion X, and the step portion X is located at a junction of the auxiliary organic dye layer 21 and the substrate 11. The step portion referred to herein is the portion of the filter unit having a width difference. In the present embodiment, left and right sides of the fourth filter unit A4 respectively have a width difference ΔW, and a difference value between the first width W1 and the second width W2 is determined by the width of the cutting line CL (as shown in FIG. 8), and the difference value is approximately twice the width difference ΔW. In an embodiment in which a cutter is used in the first cutting step, the difference value between the first width W1 and the second width W2 can be 30 to 150 microns, preferably 50 to 100 microns, and more preferably 80 to 120 microns. In an embodiment in which a laser is used in the first cutting step, the difference value between the first width W1 and the second width W2 can be 5 to 30 microns, preferably 10 to 25 microns, and more preferably 15 to 20 microns. Since the position of the step portion corresponds to the bottom of the above groove, in the fourth filter unit A4, the step portion X can also be located on the side wall of the auxiliary organic dye layer 21 or the side wall of the substrate 11.

It should be noted that when the thickness 21T of the auxiliary organic dye layer is 20 microns or greater, due to the wafer expansion technology, tearing marks easily leave on the edge of the organic dye layer or the substrate, thereby resulting in poor edge alignment of the filter unit, and further reducing the yield of the product. In contrast, in the present embodiment, a two-stage separation step (i.e., including a first cutting step and a second cutting step) is adopted, which can avoid leaving tearing marks on the edge of the organic dye layer or the substrate, thereby improving the yield of the product. In such an implementation, as long as the depth of the groove formed by the first cutting method is greater than the sum of 65% of the thickness of the auxiliary organic dye layer 21 and the thickness of the auxiliary inorganic optical composite layer 22, the depth falls within the practical applicable scope of the present embodiment.

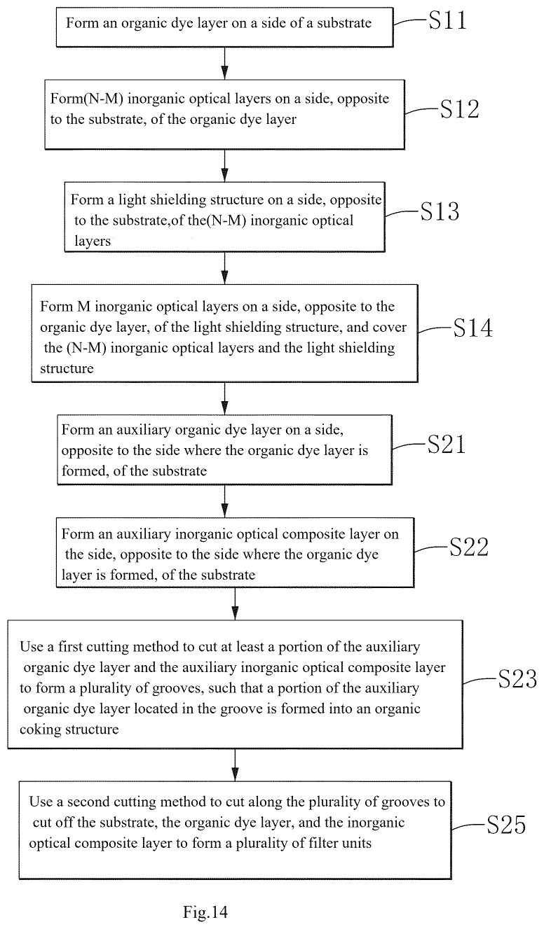

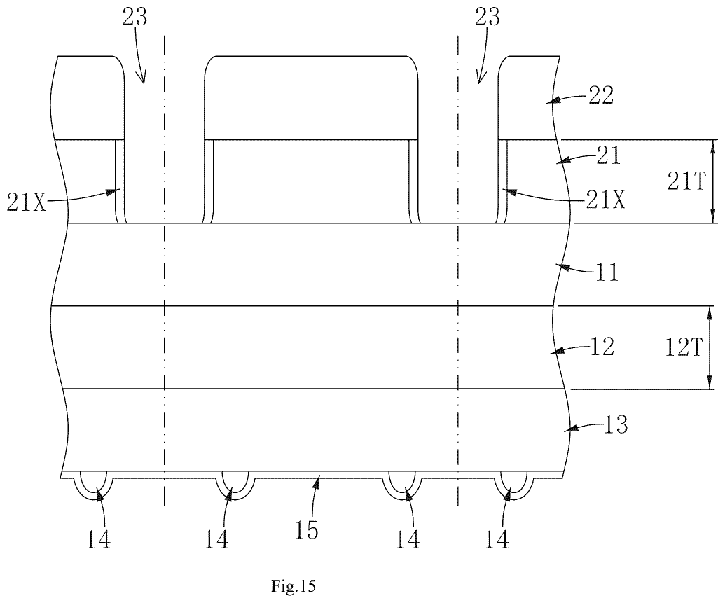

Please refer to FIG. 14 to FIG. 16 which are respectively a flow diagram of a fifth embodiment of the method for manufacturing a filter unit of the present application, a cross-sectional schematic diagram of a product after the first cutting step, and a cross-sectional schematic diagram of a fifth embodiment of the filter unit of the present application.

Please refer to the above description for the similarities between the present embodiment and the fourth embodiment, which will not be repeated herein. The difference between the present embodiment and the fourth embodiment lies in that in the method for manufacturing a filter unit of the present embodiment, a different first cutting method is used in the first cutting step S23, and in the present embodiment, the step of forming an inorganic protective layer S24 is not included. Therefore, only the first cutting step S23 of the present embodiment is described below.

The first cutting step S23 of the present embodiment is as follows: using a first cutting method to cut at least a portion of the auxiliary organic dye layer 21 and the auxiliary inorganic optical composite layer 22 to form a plurality of grooves 23. Wherein, after the first cutting step S23, a portion of the auxiliary organic dye layer 21 located in the groove will be formed into an organic coking structure 21X.

It should be particularly emphasized that in the method for manufacturing a filter unit of the present embodiment, the basic manufacturing step S11, the step of forming a first inorganic optical layer S12, the step of forming a light shielding structure S13, the step of forming a second inorganic optical layer S14, the step of forming an auxiliary organic dye layer S21, the step of forming an auxiliary inorganic optical composite layer S22, the first cutting step S23 and the second cutting step S25 should conform to the rule that the basic manufacturing step S11, the step of forming a first inorganic optical layer S12, the step of forming a light shielding structure S13 and the step of forming a second inorganic optical layer S14 should be all performed before the second cutting step S25, and the first cutting step S23 is performed between the step of forming an auxiliary organic dye layer S21 and the second cutting step S25, and the execution order of these steps is not limited to the above description.

In a specific application of the present embodiment, in the first cutting method and the second cutting method, lasers of different wavelength ranges can be respectively adopted, for example, ultraviolet lasers can be used in the first cutting method, and visible light lasers can be used in the second cutting method. More specifically, in one implementation application, the first cutting method is performed with, for example, a UV-A ultraviolet laser with a wavelength range of 315 nm to 400 nm for cutting, and the second cutting method can be performed with a green laser with a wavelength range of 510 nm to 550 nm for cutting.

In an embodiment in which an ultraviolet laser is used for cutting in the first cutting method, the auxiliary organic dye layer 21 includes, for example, a light absorbing dye (particularly an infrared light absorbing dye and an ultraviolet light absorbing dye, but not limited thereto), a binder, and a primer added as needed. When the ultraviolet laser cuts the auxiliary organic dye layer 21, the light absorbing dye and the binder in the auxiliary organic dye layer 21 will become an organic coking structure 21X after contacting with the high-energy ultraviolet laser. Similarly, if the organic dye layer 12 and the auxiliary organic dye layer 21 are made of the same material, an organic coking structure will also be formed after the organic dye layer 12 contacts with the ultraviolet laser. In the method for manufacturing a filter unit of the present embodiment, through changing the cutting method of the first cutting step S23, the outer side of the auxiliary organic dye layer 21 (i.e., the auxiliary organic dye layer annular side surface) can be completely covered and protected by the organic coking structure 21X, thereby avoiding or greatly reducing the risk of the auxiliary organic dye layer 21 being damaged in the subsequent processing process. In the present embodiment, since the organic coking structure 21X can play a similar function as the inorganic protective layer 24 of the fourth embodiment (i.e., protecting the outer side of the auxiliary organic dye layer 21), the step of forming an inorganic protective layer S24 of the fourth embodiment can be omitted, thereby reducing the process complexity and shortening the process time. In the specific application of the present embodiment, the thickness 12T of the organic dye layer is not greater than 10 microns, and the thickness 21T of the auxiliary organic dye layer is 20 microns or greater.

It should be noted that, in a specific application, an oxygen-carbon ratio (O/C ratio) of the organic coking structure 21X can be 1.18 to 1.66, such that it can be guaranteed that the organic coking structure 21X can play a good role in protecting the organic dye layer 12 and the auxiliary organic dye layer 21. In a specific application, the oxygen-carbon ratio of the organic coking structure 21X can be 2.46 to 6.92 times an oxygen-carbon ratio of the auxiliary organic dye layer 21 that is not irradiated by a laser. In practice, the elemental analysis of the organic coking structure can be performed by using energy-dispersive X-ray spectroscopy (EDX) to confirm the oxygen-carbon ratio of the organic coking structure.

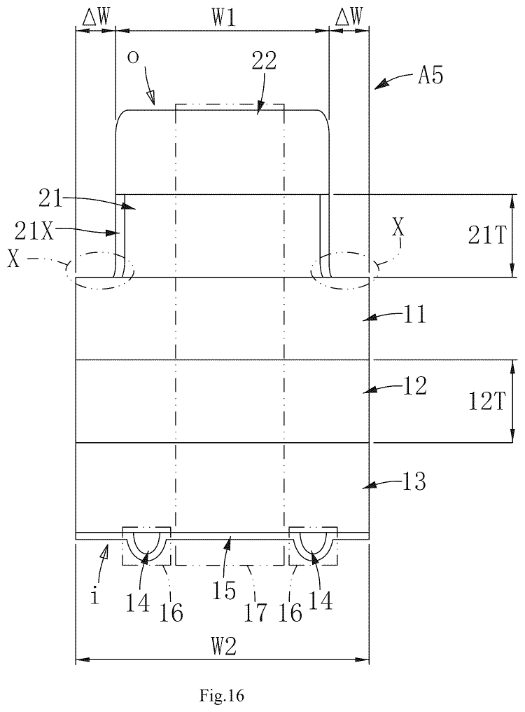

As shown in FIG. 16, the main difference between a fifth filter unit A5 of the present embodiment and the fourth filter unit A4 of the fourth embodiment (as shown in FIG. 13) lies in that the fifth filter unit A5 is not provided with an inorganic protective layer 24, but at least a portion of the auxiliary organic dye layer annular side surface of the fifth filter unit A5 (or the entire organic dye layer annular side surface) is covered by the organic coking structure 21X. The fifth filter unit A5 can be manufactured using the method for manufacturing a filter unit of the fifth embodiment, but is not limited thereto.

As shown in FIG. 16, in a practical application of the present embodiment, two opposite sides of the fifth filter unit A5 are respectively defined as a light incoming side i and a light outgoing side o, and a side of the fifth filter unit A5 having the light shielding structure 14 is the light incoming side i; wherein, after a light beam with a wavelength range of 350 nm to 1000 nm enters the light transmitting portion 17 of the fifth filter unit A5 from the light incoming side i, the transmittance of the light beam with a wavelength range of 450 nm to 580 nm is 80% or greater, and the transmittance of the light beam with a wavelength range of 750 nm to 1000 nm is 5% or less. In practical applications, those skilled in the art can refer to the above design principles and determine the main constituent material and related thickness of each layer according to the filtering requirements of the fifth filter unit A5. Please refer to the above description for specific designs, which will not be repeated herein.

As shown in FIG. 16, when viewed from a cross-sectional direction, upper and lower sides of the fifth filter unit A5 respectively have a first width W1 and a second width W2, and W1 is less than W2; in addition, each of two side walls of the fifth filter unit A5 has a step portion X, and the step portion X is located at the junction of the auxiliary organic dye layer 21 and the substrate 11. In the present embodiment, left and right sides of the fifth filter unit A5 respectively have a width difference ΔW, and a difference value between the first width W1 and the second width W2 is determined by the width of the cutting line CL (as shown in FIG. 8), and the difference value is approximately twice the width difference ΔW. In an embodiment in which the first cutting step S23 is performed by a laser, the difference value between the first width W1 and the second width W2 can be 5 to 30 microns, preferably 10 to 25 microns, and more preferably 15 to 20 microns.

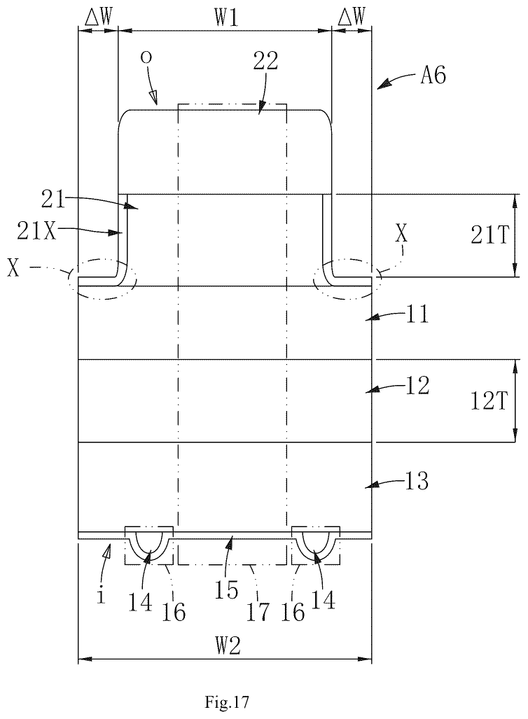

Please refer to FIG. 16 and FIG. 17, FIG. 17 is a cross-sectional schematic diagram of a sixth embodiment using the filter unit of the present application. Please refer to the above description for the similarities between the present embodiment and the fifth embodiment, which will not be repeated herein. The difference between a sixth filter unit A6 of the present embodiment and the fifth filter unit A5 of the above fifth embodiment lies in that the shape of the organic coking structure 21X in the cross-sectional view is different. In the present embodiment, when the above groove is formed, only a portion of the auxiliary organic dye layer 21 is cut (that is, the cutting depth is less than the thickness 21T of the auxiliary organic dye layer), and the substrate 11 is not cut. Therefore, in the cross section of the sixth filter unit A6, the organic coking structure 21X is approximately L-shaped, and the step portion X is located on the side wall of the auxiliary organic dye layer 21, and the organic coking structure 21X covers 65% or greater of the auxiliary organic dye layer annular side surface 211. In the above fifth embodiment, when the above groove is formed, the substrate 11 is approximately cut. Therefore, in the cross-sectional view of the fifth filter unit A5, the organic coking structure 21X is approximately I-shaped and the organic coking structure 21X completely covers the auxiliary organic dye layer annular side surface 211.

As shown in FIG. 17, in a practical application of the present embodiment, two opposite sides of the sixth filter unit A6 are respectively defined as a light incoming side i and a light outgoing side o, and a side of the sixth filter unit A6 having the light shielding structure 14 is the light incoming side i; wherein, after a light beam with a wavelength range of 350 nm to 1000 nm enters the light transmitting portion 17 of the sixth filter unit A6 from the light incoming side i, the transmittance of the light beam with a wavelength range of 450 nm to 580 nm is 80% or greater, and the transmittance of the light beam with a wavelength range of 750 nm to 1000 nm is 5% or less. In practical applications, those skilled in the art can refer to the above design principles and determine the main constituent material and related thickness of each layer according to the filtering requirements of the sixth filter unit A6. Please refer to the above description for specific designs, which will not be repeated herein.

As described above, in the method for manufacturing a filter unit of the fifth and sixth embodiments, the organic coking structure 21X can be formed to protect the auxiliary organic dye layer annular side surface 211, thereby avoiding or significantly reducing damage to the auxiliary organic dye layer 21 in subsequent related processing.

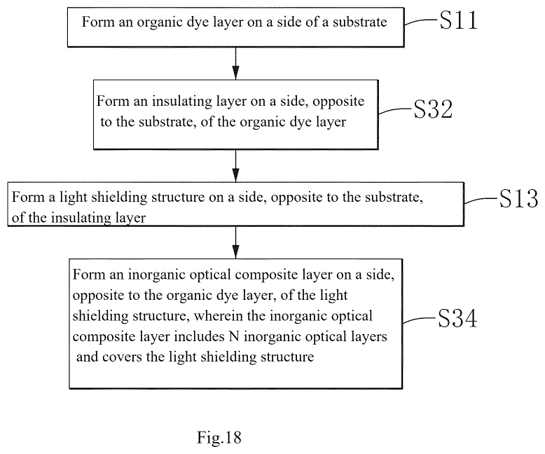

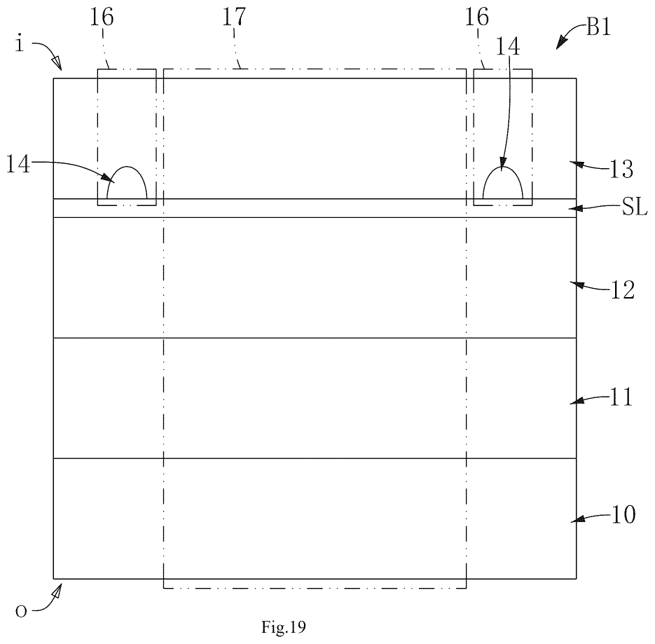

Please refer to FIG. 18 and FIG. 19 which are respectively a flow diagram of a seventh embodiment of the method for manufacturing a filter unit of the present application and a cross-sectional schematic diagram of a seventh embodiment of the filter unit. The method for manufacturing a filter unit of the present embodiment includes: a basic manufacturing step S11, a step of forming an insulating layer S32, a step of forming a light shielding structure S13 and a step of forming an inorganic optical composite layer S34. The same steps as the above embodiment are not repeated herein. The step of forming an insulating layer S32 is as follows: forming an insulating layer SL on a side, opposite to the substrate 11, of the organic dye layer 12. The step of forming a light shielding structure S13 is as follows: forming a light shielding structure 14 on a side, opposite to the substrate 11, of the insulating layer SL. The step of forming an inorganic optical composite layer S34 is as follows: forming an inorganic optical composite layer on a side, opposite to the organic dye layer 12, of the light shielding structure 14, wherein the inorganic optical composite layer includes N inorganic optical layers 13, which cover the light shielding structure 14, wherein N>0, and N is an integer. Wherein, the light shielding structure 14 and the inorganic optical composite layer covering the light shielding structure 14 together form a light blocking portion 16, and the inorganic optical composite layer in the light blocking portion 16 (i.e., the N inorganic optical layers 13) is used as an inorganic light shielding structure protective layer; and the light blocking portion 16 has a reflectivity of 1% or less for a light beam with a wavelength range of 500 nm to 775 nm when the incident angle is in a range of 0 to 5 degrees.

In the present embodiment, in the step of forming an insulating layer S32, sputtering may not be used, and the inorganic optical layer not mentioned above may be selected as the material of the insulating layer SL. As mentioned above, the insulating layer SL is mainly configured to prevent the organic dye layer 12 and the light shielding structure 14 from interacting during the manufacturing process. Therefore, in practical applications, any material that is insoluble in (or has extremely poor solubility in) an organic solvent used to form the light shielding structure 14 may be used as the material of the insulating layer SL.

In addition, in order to avoid affecting the optical properties of a final seventh filter unit B1, the material of the insulating layer SL is preferably a material with a high transmittance for the light that can pass through the seventh filter unit B1. For example, assuming that the seventh filter unit B1 is ultimately used in a camera to filter invisible light and allow visible light to pass through, a material with good transparency for light in a visible optical band can be selected as the material of the insulating layer SL. For example, the material that can be used for the insulating layer SL includes a cured primer, etc., and the insulating layer SL can be formed by spin coating, blade coating or other suitable processes, but is not limited thereto. In a practical application, the transmittance in the insulating layer SL within a wavelength range of 400 nm to 700 nm is greater than 98%, and the thickness of the insulating layer SL is 30 nm or less. Through such a design, even if the seventh filter unit B1 is provided with the insulating layer SL, the insulating layer SL will basically not significantly affect the original predetermined filtering effect of the filter unit.

In the present embodiment, in the step of forming an insulating layer S32 and in the step of forming an inorganic optical composite layer S34, the insulating layer SL and the N inorganic optical layers are respectively formed by a process different from that in the above embodiments. Through such a design, the step of forming an insulating layer S32 can be more easily integrated between the basic manufacturing step S11 and the step of forming an inorganic optical composite layer S34. In particular, in the present embodiment, N inorganic optical layers can be formed by a sputtering process continuously and uninterruptedly after forming the insulating layer SL and the light shielding structure 14. Compared with the first embodiment, an extension of process time caused by the interruption of the sputtering process can be avoided, thereby shortening the process time.

As shown in FIG. 19, in a practical application of the present embodiment, two opposite sides of the seventh filter unit B1 are respectively defined as a light incoming side i and a light outgoing side o, and a side of the seventh filter unit B1 having the light shielding structure 14 is the light incoming side i; wherein, after a light beam with a wavelength range of 350 nm to 1000 nm enters the light transmitting portion 17 of the seventh filter unit B1 from the light incoming side i, the transmittance of the light beam with a wavelength range of 450 nm to 580 nm is 80% or greater, and the transmittance of the light beam with a wavelength range of 750 nm to 1000 nm is 5% or less. In practical applications, those skilled in the art can refer to the above design principles, and modify, for example, the thickness of the insulating layer SL and its main material, the thickness of the organic dye layer 12 and its main material, the number of inorganic optical layers with different refractive indices included in the inorganic optical composite layer (and/or the balanced inorganic optical composite layer 10), the thickness of each layer, and the refractive index of each layer, such that the light transmitting portion 17 of the seventh filter unit B1 can achieve the effect of filtering light beams of a specific wavelength.

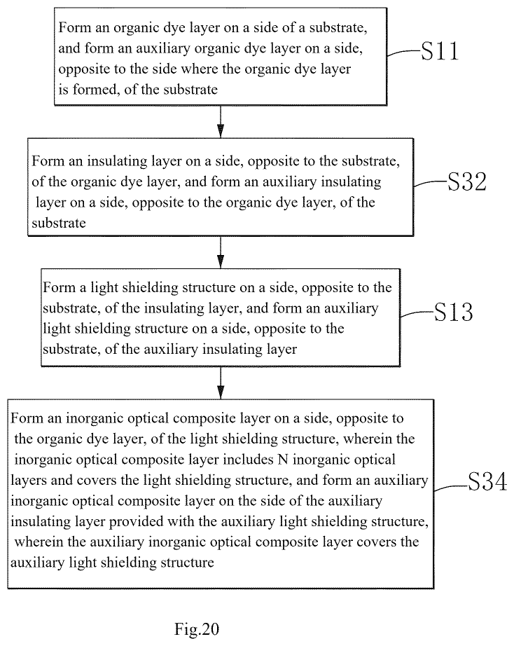

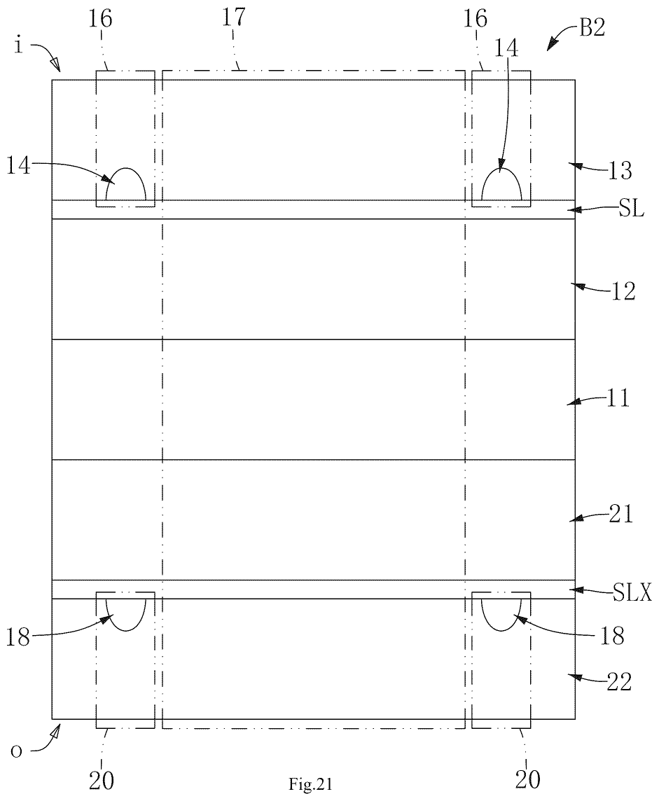

Please refer to FIG. 20 and FIG. 21 which are respectively a flow diagram of an eighth embodiment of the method for manufacturing a filter unit of the present application and a cross-sectional schematic diagram of an eighth embodiment of the filter unit. The difference between the present embodiment and the seventh embodiment lies in that in the basic manufacturing step S11, an auxiliary organic dye layer 21 is formed on the side, opposite to the organic dye layer 12, of the substrate 11; in the step of forming an insulating layer S32, an auxiliary insulating layer SLX is formed on the side, opposite to the organic dye layer 12, of the substrate 11 (i.e., the side, opposite to the substrate 11, of the auxiliary organic dye layer 21), and the auxiliary insulating layer SLX covers the auxiliary organic dye layer 21; in the step of forming a light shielding structure S13, an auxiliary light shielding structure 18 is formed on the side, opposite to the substrate 11, of the auxiliary insulating layer SLX; in the step of forming an inorganic optical composite layer S34, an auxiliary inorganic optical composite layer 22 is formed on the side of the auxiliary insulating layer SLX provided with the auxiliary light shielding structure 18, and the auxiliary inorganic optical composite layer 22 covers the auxiliary light shielding structure 18. Similar to the seventh embodiment, in a practical application of the present embodiment, the transmittance in the insulating layer SL within a wavelength range of 400 nm to 700 nm is greater than 98%, and the thickness of the insulating layer SL is 30 nm or less. Through such a design, even if an eighth filter unit B2 is provided with the insulating layer SL, the insulating layer SL will basically not significantly affect the original predetermined filtering effect of the filter unit.

In the present embodiment, the inorganic light shielding structure protective layer is the N inorganic optical layers 13 located in the light blocking portion 16, and the auxiliary inorganic light shielding structure protective layer is the auxiliary inorganic optical composite layer 22 located in the auxiliary light blocking portion 20. Similar to the seventh embodiment, in the present embodiment, after forming the insulating layer SL and the light shielding structure 14, the N inorganic optical layers can be continuously and uninterruptedly formed by a sputtering process; and/or after forming the auxiliary insulating layer SLX and the auxiliary light shielding structure 18, the auxiliary inorganic optical composite layers 22 can be continuously and uninterruptedly formed by a sputtering process. Compared with the second embodiment, an extension of process time caused by the interruption of the sputtering process can be avoided, thereby shortening the process time.

As shown in FIG. 21, in a practical application of the present embodiment, two opposite sides of the eighth filter unit B2 are respectively defined as a light incoming side i and a light outgoing side o, and a side of the eighth filter unit B2 having the light shielding structure 14 is the light incoming side i; wherein, after a light beam with a wavelength range of 350 nm to 1000 nm enters the light transmitting portion 17 of the eighth filter unit B2 from the light incoming side i, the transmittance of the light beam with a wavelength range of 450 nm to 580 nm is 80% or greater, and the transmittance of the light beam with a wavelength range of 750 nm to 1000 nm is 5% or less. In practical applications, those skilled in the art can refer to the above design principles and determine the main constituent material and related thickness of each layer according to the filtering requirements of the eighth filter unit B2. Please refer to the above description for specific designs, which will not be repeated herein.

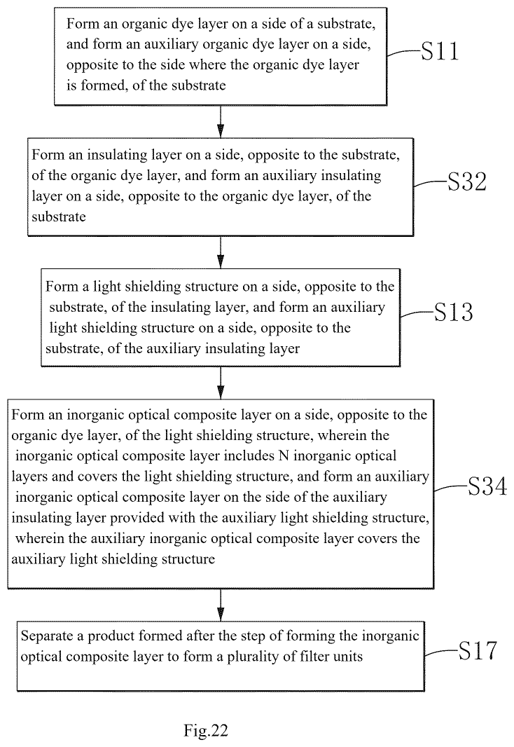

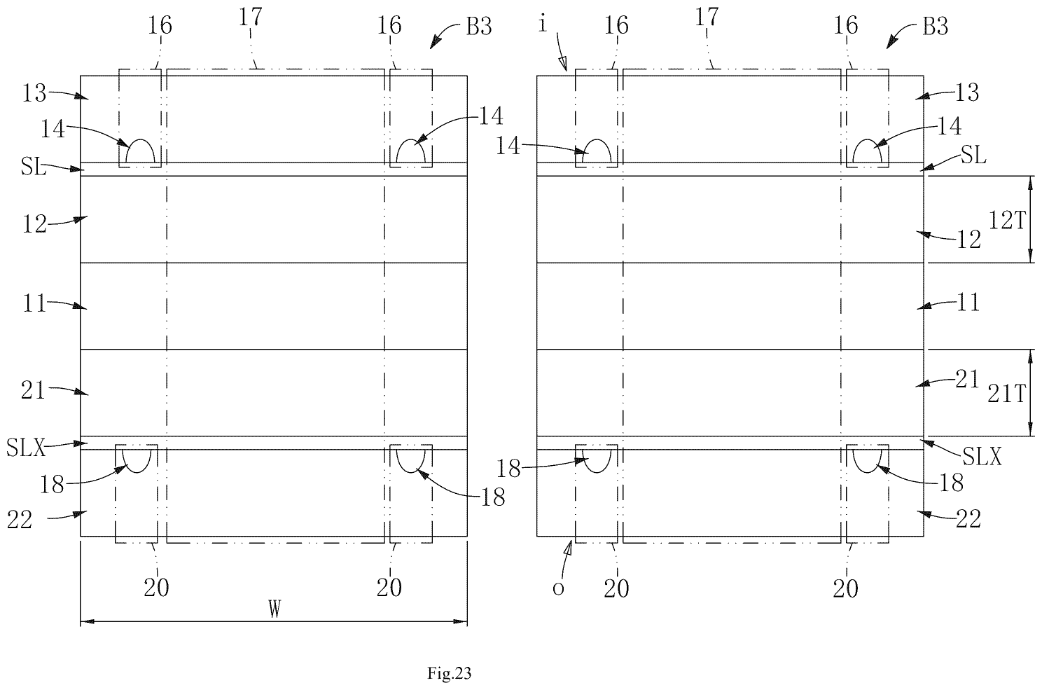

Please refer to FIG. 22 and FIG. 23 which are respectively a flow diagram of a ninth embodiment of the method for manufacturing a filter unit of the present application and a cross-sectional schematic diagram of a ninth embodiment of the filter unit. The difference between the present embodiment and the eighth embodiment lies in that after the step of forming an inorganic optical composite layer S34, a separation step S17 is further included: separating a product formed by the step of forming an inorganic optical composite layer S34 to form a plurality of ninth filter units B3.

Similar to the seventh embodiment, in a practical application of the present embodiment, the transmittance in the insulating layer SL within a wavelength range of 400 nm to 700 nm is greater than 98%, and the thickness of the insulating layer SL is 30 nm or less. Through such a design, even if the ninth filter unit B3 is provided with the insulating layer SL, the insulating layer SL will basically not significantly affect the original predetermined filtering effect of the filter unit.

Similar to the third embodiment, in the seventh to ninth embodiments, the basic manufacturing step, the step of forming an insulating layer, the step of forming a light shielding structure and the step of forming a second inorganic optical layer are all performed on a large-sized substrate 11. Therefore, in the step of forming a light shielding structure S13, a plurality of annular light shielding structures 14 (as shown in FIG. 8) which are not connected to each other are formed on the side, opposite to the organic dye layer, of the inorganic optical composite layer, and a distance slightly greater than the width of the cutting line CL is reserved between every two light shielding structures 14. In an embodiment in which the thickness 12T of the organic dye layer and the thickness 21T of the auxiliary organic dye layer are both not greater than 10 microns, in the separation step S17, a laser or a cutter may be used, or a stealth laser wafer dicing technology may be used in combination with a wafer expansion process to perform separation at one time to form a plurality of filter units.

In practical applications, if in the separation step S17, a laser or a cutter is used to cut and form a plurality of filter units at one time, and the width of any section of each filter unit will be approximately equal. It should be noted that when the thickness 12T of the organic dye layer and the thickness 21T of the auxiliary organic dye layer are both not greater than 10 microns, the tearing marks left on the edge of the organic dye layer due to the above wafer expansion process are tolerable and have a little influence on the yield of the product. Therefore, the one-stage separation step is adopted in the present embodiment, which can shorten the process time and further improve the production efficiency of the product. As shown in FIG. 23, since a one-time/one-stage separation method is adopted, when observed from the cross-sectional direction, the widths of upper and lower sides of the ninth filter unit B3 are substantially the same, and side walls of the ninth filter unit B3 are approximately straight.

In practical applications, the inorganic light shielding structure protective layer is the N inorganic optical layers 13 located in the light blocking portion 16, and the auxiliary inorganic light shielding structure protective layer is the auxiliary inorganic optical composite layer 22 located in the auxiliary light blocking portion 20. Similar to the seventh embodiment, in the present embodiment, after forming the insulating layer SL and the light shielding structure 14, the N inorganic optical layers can be continuously and uninterruptedly formed by a sputtering process; and/or after forming the auxiliary insulating layer SLX and the auxiliary light shielding structure 18, the auxiliary inorganic optical composite layer 22 can be continuously and uninterruptedly formed by a sputtering process. Compared with the third embodiment, an extension of process time caused by the interruption of the sputtering process can be avoided, thereby shortening the process time.

As shown in FIG. 23, in a practical application of the present embodiment, two opposite sides of the ninth filter unit B3 are respectively defined as a light incoming side i and a light outgoing side o, and a side of the ninth filter unit B3 having the light shielding structure 14 is the light incoming side i; wherein, after a light beam with a wavelength range of 350 nm to 1000 nm enters the light transmitting portion 17 of the ninth filter unit B3 from the light incoming side i, the transmittance of the light beam with a wavelength range of 450 nm to 580 nm is 80% or greater, and the transmittance of the light beam with a wavelength range of 750 nm to 1000 nm is 5% or less. In practical applications, those skilled in the art can refer to the above design principles and determine the main constituent material and related thickness of each layer according to the filtering requirements of the ninth filter unit B3. Please refer to the above description for specific designs, which will not be repeated herein.

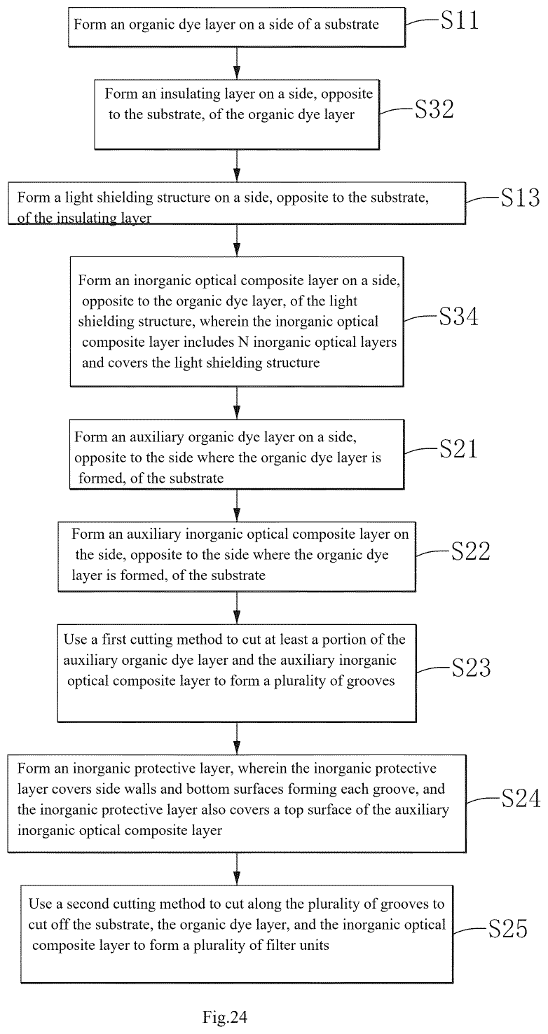

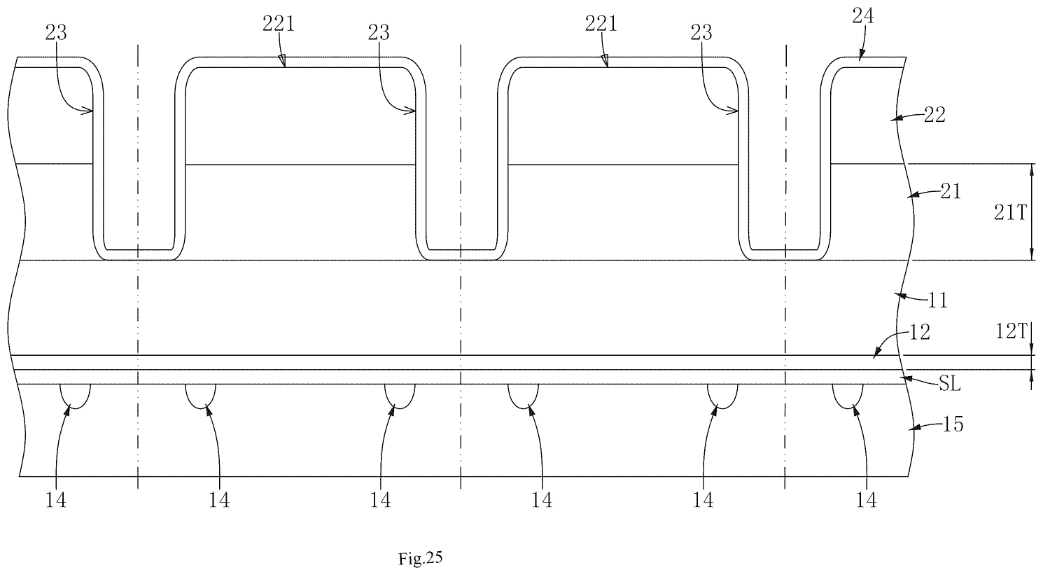

Please refer to FIGS. 24 to 26 which are respectively a flow diagram of a tenth embodiment of the method for manufacturing a filter unit of the present application, a cross-sectional schematic diagram of a product after the step of forming an inorganic protective layer of the present embodiment, and a cross-sectional schematic diagram of a tenth embodiment of the filter unit. Please refer to the above description for the similarities between the present embodiment and the fourth and seventh embodiments, which will not be repeated herein. Similar to the seventh embodiment, in a practical application of the present embodiment, the transmittance in the insulating layer SL within a wavelength range of 400 nm to 700 nm is greater than 98%, and the thickness of the insulating layer SL is 30 nm or less. Through such a design, even if a tenth filter unit B4 is provided with the insulating layer SL, the insulating layer SL will basically not significantly affect the original predetermined filtering effect of the filter unit.

In practical applications, the inorganic light shielding structure protective layer 15 located in the light blocking portion 16 and the inorganic optical composite layer located in the light transmitting portion 17 are the same N inorganic optical layers. Similar to the seventh embodiment, in the present embodiment, after forming the insulating layer SL and the light shielding structure 14, the N inorganic optical layers can be continuously and uninterruptedly formed by a sputtering process. Compared with the fourth embodiment, an extension of process time caused by the interruption of the sputtering process can be avoided, thereby shortening the process time.

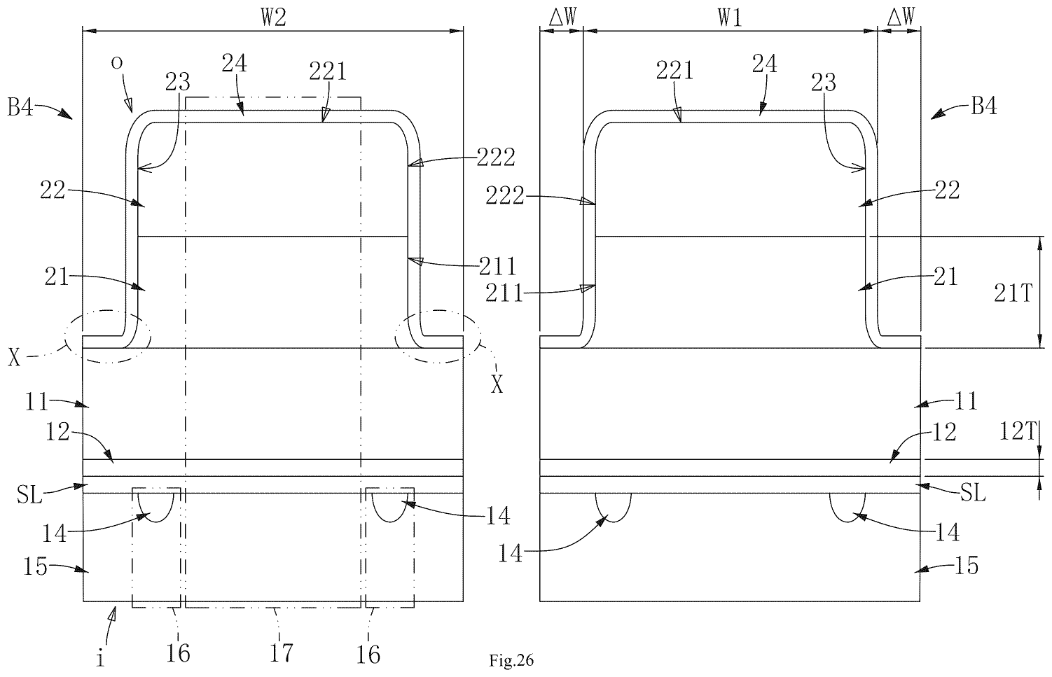

Similar to the fourth embodiment, in the present embodiment, a first cutting step, a second cutting step and a step of forming an inorganic protective layer are included, such that the auxiliary organic dye layer annular side surface 211 included in each finally formed filter unit can be covered by the inorganic protective layer 24. Through such a design, the risk of the auxiliary organic dye layer 21 being destroyed or damaged in subsequent processing processes (such as a high temperature and high pressure environmental testing process) can be effectively reduced. As shown in FIG. 26, when observed from the cross-sectional direction, upper and lower sides of the tenth filter unit B4 have a first width W1 and a second width W2, respectively, and W1 is less than W2; in addition, each of two side walls of the tenth filter unit B4 has a step portion X, and the step portion X is located at the junction of the auxiliary organic dye layer 21 and the substrate 11.

In the present embodiment, left and right sides of the tenth filter unit B4 respectively have a width difference ΔW, and a difference value between the first width W1 and the second width W2 is determined by the width of the cutting line CL (as shown in FIG. 8), and the difference value is approximately twice the width difference ΔW. For the applicable range or desired range of the width difference ΔW, please refer to the description of the above fourth embodiment, which will not be repeated herein. Since the position of the step portion corresponds to the bottom of the above groove, the step portion X in the tenth filter unit B4 can also be located on the side wall of the auxiliary organic dye layer 21 or the side wall of the substrate 11.

Similar to the fourth embodiment, a two-stage separation step (i.e., including a first cutting step and a second cutting step) is adopted in the present embodiment, which can avoid leaving tearing marks on the edge of the organic dye layer or the substrate, thereby improving the yield of the product. In such an implementation, as long as the depth of the groove formed by the first cutting method is greater than the sum of 65% of the thickness of the auxiliary organic dye layer 21 and the thickness of the auxiliary inorganic optical composite layer, the depth falls within the practical applicable scope of the present embodiment.

As shown in FIG. 26, in a practical application of the present embodiment, two opposite sides of the tenth filter unit B4 are respectively defined as a light incoming side i and a light outgoing side o, and a side of the tenth filter unit B4 having the light shielding structure 14 is the light incoming side i; wherein, after a light beam with a wavelength range of 350 nm to 1000 nm enters the light transmitting portion 17 of the tenth filter unit B4 from the light incoming side i, the transmittance of the light beam with a wavelength range of 450 nm to 580 nm is 80% or greater, and the transmittance of the light beam with a wavelength range of 750 nm to 1000 nm is 5% or less. In practical applications, those skilled in the art can refer to the above design principles and determine the main constituent material and related thickness of each layer according to the filtering requirements of the tenth filter unit B4. Please refer to the above description for specific designs, which will not be repeated herein.

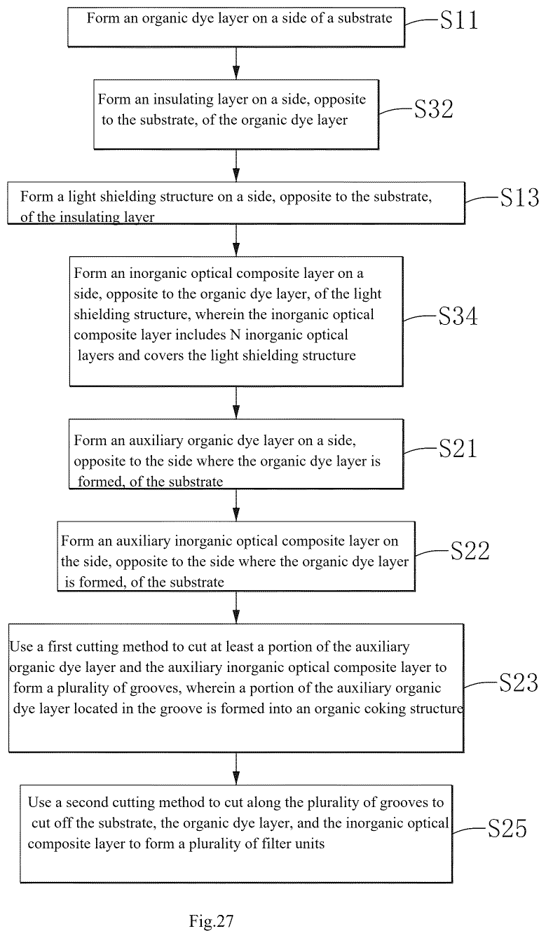

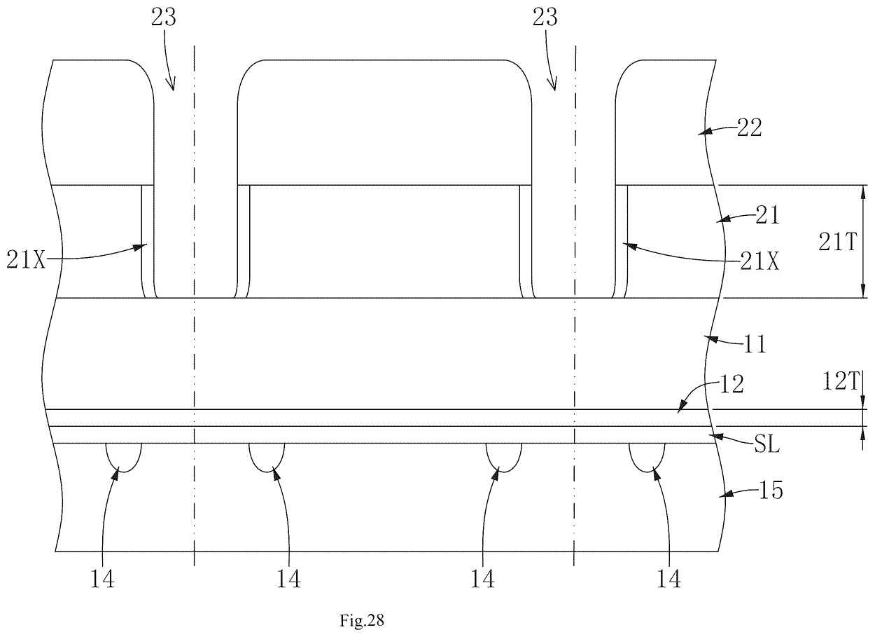

Please refer to FIGS. 27 to 30 which are respectively a flow diagram of an eleventh embodiment of the method for manufacturing a filter unit of the present application, a cross-sectional schematic diagram of a product after the first cutting step, a cross-sectional schematic diagram of an eleventh embodiment of the filter unit, and a cross-sectional schematic diagram of a twelfth embodiment of the filter unit. Please refer to the above description for the similarities between the eleventh and twelfth embodiments and the above fifth to seventh embodiments, which will not be repeated herein. Similar to the seventh embodiment, in a practical application of the present embodiment, the transmittance in the insulating layer SL within a wavelength range of 400 nm to 700 nm is greater than 98%, and the thickness of the insulating layer SL is 30 nm or less. Through such a design, even if an eleventh filter unit B5 (or a twelfth filter unit B6) is provided with the insulating layer SL, the insulating layer SL will basically not significantly affect the original predetermined filtering effect of the filter unit.

In practical applications, the inorganic light shielding structure protective layer 15 located in the light blocking portion 16 and the inorganic optical composite layer located in the light transmitting portion 17 are the same N inorganic optical layers. Similar to the seventh embodiment, in the eleventh and twelfth embodiments, after forming the insulating layer SL and the light shielding structure 14, the N inorganic optical layers can be continuously and uninterruptedly formed by a sputtering process. Compared with the fifth and sixth embodiments, an extension of process time caused by the interruption of the sputtering process can be avoided, thereby shortening the process time.

In the eleventh and twelfth embodiments, in the first cutting method and the second cutting method, lasers of different wavelength ranges can be respectively adopted, for example, ultraviolet lasers can be used in the first cutting method, and visible light lasers can be used in the second cutting method. More specifically, in one implementation application, the first cutting method is performed with, for example, a UV-A ultraviolet laser with a wavelength range of 315 nm to 400 nm for cutting, and the second cutting method can be performed with a green laser with a wavelength range of 510 nm to 550 nm for cutting. In the embodiment in which an ultraviolet laser is used for cutting in the first cutting method, the auxiliary organic dye layer 21 includes, for example, a light absorbing dye (particularly an infrared light absorbing dye and an ultraviolet light absorbing dye, but not limited thereto), a binder, and a primer added as needed. When the ultraviolet laser cuts the auxiliary organic dye layer 21, the light absorbing dye and the binder in the auxiliary organic dye layer 21 will become an organic coking structure 21X after contacting with the high-energy ultraviolet laser. Similarly, if the organic dye layer 12 and the auxiliary organic dye layer 21 are made of the same material, then the organic coking structure will also be formed after the organic dye layer 12 contacts with the ultraviolet laser.

In the method for manufacturing a filter unit of the eleventh and twelfth embodiments, the outer side of the auxiliary organic dye layer 21 (i.e., the auxiliary organic dye layer annular side surface) can be completely or partially covered and protected by the organic coking structure 21X by changing the cutting method of the first cutting step S23, thereby avoiding or greatly reducing the risk of the auxiliary organic dye layer 21 being damaged during the subsequent processing processes. In the eleventh and twelfth embodiments, since the organic coking structure 21X can play a function similar to that of the inorganic protective layer 24 of the tenth embodiment (i.e., protecting the outer side of the auxiliary organic dye layer 21), the step of forming an inorganic protective layer S24 of the tenth embodiment can be omitted, thereby reducing the process complexity and shortening the process time. In the specific application of the eleventh and twelfth embodiments, the thickness 12T of the organic dye layer is not greater than 10 microns, and the thickness 21T of the auxiliary organic dye layer is 20 microns or greater.

It should be noted that, in a specific application, the oxygen-carbon ratio (O/C ratio) of the organic coking structure 21X can be 1.18 to 1.66, such that it can be guaranteed that the organic coking structure can play a good role in protecting the organic dye layer 12 and the auxiliary organic dye layer 21. In a specific application, the oxygen-carbon ratio of the organic coking structure 21X can be 2.46 to 6.92 times the oxygen-carbon ratio of the auxiliary organic dye layer 21 that is not irradiated by a laser. In practice, the elemental analysis of the organic coking structure can be performed by using energy-dispersive X-ray spectroscopy to confirm the oxygen-carbon ratio of the organic coking structure.

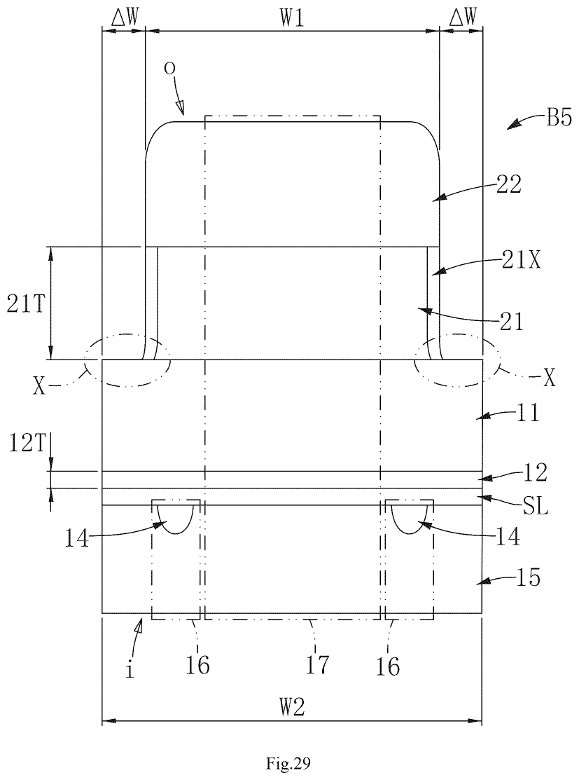

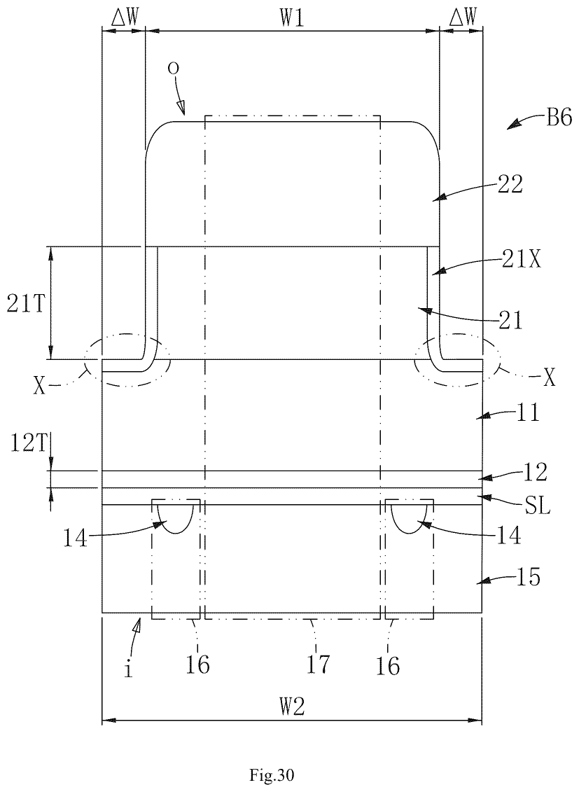

As shown in FIG. 29 and FIG. 30, the main difference between the eleventh filter unit B5 and B6 of the eleventh and twelfth embodiments and the tenth filter unit B4 of the above tenth embodiment (as shown in FIG. 26) lies in that the eleventh filter unit B5 and B6 are not provided with an inorganic protective layer 24, but at least a portion of the auxiliary organic dye layer annular side surface 211 of the eleventh filter unit B5 and B6 (or the entire auxiliary organic dye layer annular side surface 211) is covered by the organic coking structure 21X. In addition, the difference between the eleventh filter unit B5 of the eleventh embodiment and the twelfth filter unit B6 of the twelfth embodiment lies in that the shape of the organic coking structure 21X in the cross-sectional view is different. In the cross-sectional view of the twelfth filter unit B6, the organic coking structure 21X is approximately L-shaped, and the step portion X is located on the side wall of the auxiliary organic dye layer 21, and the organic coking structure 21X covers 65% or greater of the auxiliary organic dye layer annular side surface 211. In the cross-sectional view of the eleventh filter unit B5, the organic coking structure 21X is approximately I-shaped, and the step portion X is located at the junction of the auxiliary organic dye layer 21 and the substrate 11, while the organic coking structure 21X completely covers the auxiliary organic dye layer annular side surface 211.

As shown in FIG. 29 (or FIG. 30), when viewed from the cross-sectional direction, upper and lower sides of the eleventh filter unit B5 (or B6) respectively have a first width W1 and a second width W2, and W1 is less than W2; in addition, each of two side walls of the eleventh filter unit B5 (or B6) has a step portion X (or B6X), and the step portion X (or B6X) is located at the junction of the auxiliary organic dye layer 21 and the substrate 11 (or the side wall of the auxiliary organic dye layer 21). In the present embodiment, left and right sides of the eleventh filter unit B5 (or B6) respectively have a width difference ΔW, and a difference value between the first width W1 and the second width W2 is determined by the width of the cutting line CL (as shown in FIG. 8), and the difference value is about twice the width difference ΔW. In the embodiment in which a laser is used in the first cutting step S23, the difference value between the first width W1 and the second width W2 can be 5 to 30 microns, preferably 10 to 25 microns, and more preferably 15 to 20 microns.

As shown in FIG. 29 (or FIG. 30), in the practical application of the eleventh (or twelfth) embodiment, two opposite sides of the eleventh filter unit B5 (or the twelfth filter unit B6) are respectively defined as a light incoming side i and a light outgoing side o, and a side of the filter unit having the light shielding structure 14 is the light incoming side i; wherein, after a light beam with a wavelength range of 350 nm to 1000 nm enters the light transmitting portion 17 of the eleventh filter unit B5 (or the twelfth filter unit B6) from the light incoming side i, the transmittance of the light beam with a wavelength range of 450 nm to 580 nm is 80% or greater, and the transmittance of the light beam with a wavelength range of 750 nm to 1000 nm is 5% or less. In practical applications, those skilled in the art can refer to the above design principles and determine the main constituent material and related thickness of each layer according to the filtering requirements of the eleventh filter unit B5 (or B6). Please refer to the above description for the specific design, which will not be repeated herein.

As described above, in the method for manufacturing a filter unit of the eleventh and twelfth embodiments, the organic coking structure 21X can be formed to protect the auxiliary organic dye layer annular side surface 211, thereby avoiding or significantly reducing damage to the auxiliary organic dye layer 21 in subsequent related processing.

It should be particularly noted that in the above first to twelfth embodiments, after the inorganic light shielding structure protective layer is formed, one or more cleaning steps can be performed to clean the filter unit. In the cleaning step, for example, the filter unit is cleaned by plasma or chemical detergent. The chemical detergent may include but is not limited to: sodium hydroxide (NaOH) with a pH value of 13.5 and a mass percentage of 5%, sulfuric acid (H2SO4) with a pH value of 0.89 and a mass percentage of 5%, or other chemical detergents that can be used to clean glass or silicon wafers. In a specific application, two cleaning steps may also be performed, wherein in one cleaning step, the filter unit is immersed in a solution of sodium hydroxide (NaOH) with a pH value of 13.5 and a mass percentage of 5% for 48 hours, and in the other cleaning step, the filter unit is immersed in a solution of sulfuric acid (H2SO4) with a pH value of 0.89 and a mass percentage of 5% for 48 hours. In a practical application, after forming the inorganic light shielding structure protective layer, two cleaning steps may also be performed, plasma is used in one of the cleaning steps and chemical detergent is used in the other cleaning step. In a variant embodiment, in the cleaning step, ultrasonic vibration cleaning, spray cleaning, brushing and the like can also be used for cleaning according to requirements.

Relevant steps of forming the inorganic light shielding structure protective layer are included in the method for manufacturing a filter unit of all the embodiments of the present application, such that the light shielding structure of the filter unit will be covered by the inorganic light shielding structure protective layer. Therefore, the filter unit manufactured by such a method can be cleaned by plasma or chemical detergent according to actual requirements. In contrast, in the existing method for manufacturing a filter unit, due to a lack of the design of the step of forming a light shielding protective layer, the light shielding structure of the filter unit manufactured by the existing method for manufacturing a filter unit will be exposed. If the filter unit is cleaned by plasma or chemical detergent, the light shielding structure will be damaged. In other words, the light shielding structure included in the existing filter unit is not covered by any protective structure, therefore, the existing filter unit cannot be cleaned by plasma or chemical detergent, and the yield of the product will be greatly reduced due to the contamination of the surface of the filter unit by particles. Alternatively, those skilled in the art must use other relatively complicated procedures and methods to clean the filter unit to meet the requirements of customers for the cleanliness of the filter unit, thereby greatly increasing the production cost.

It should be noted that in an embodiment in which the main material of the light shielding structure includes a metal or a metal oxide (e.g., chromium oxide and chromium) subjected to surface roughening, or in an embodiment in which the main material of the light shielding structure includes carbon black, a binder, a resin, or a curing agent, if the light shielding structure directly contacts with chemical detergent with strong oxidizing power or corrosiveness, then the light shielding structure will be basically damaged. In contrast, if the filter unit is manufactured using the method for manufacturing a filter unit of the embodiment of the present application, the outer side of the light shielding structure included therein is covered with an inorganic light shielding structure protective layer. Therefore, even if the filter unit is placed in the chemical detergent for 48 hours, the inorganic light shielding structure protective layer can still effectively protect the light shielding structure from being damaged by the chemical detergent.

In addition, in the conventional art, a protective film is affixed to the filter unit before shipment to prevent the outer surface of the filter unit from being contaminated with dust and other foreign matters during transportation. After receiving the filter unit, manufacturers purchasing the filter unit will first tear off the protective film before installing the filter unit in the desired product. In the existing practical applications, in the process of tearing off the protective film, adhesive of the protective film often remains on the filter unit (especially the light shielding structure). Furthermore, if the adhesive force between the light shielding structure and the protective film is too strong, part of the light shielding structure will be torn off along with the protective film, and consequently the filter unit is scrapped and unusable. In particular, in the conventional art, as the filter unit is stored for a longer period after the filter unit is affixed with a protective film, the adhesive force between the light shielding structure and the protective film will increase accordingly. In this way, the above problems of residual adhesive and scrapping of the filter unit will become more serious as the shelf life prolongs. It should be noted that when the light shielding structure is not covered by the inorganic light shielding structure protective layer, if the filter unit is cleaned with chemical detergent or plasma, the light shielding structure will be damaged, and internal holes of the light shielding structure will increase, and the contact area and adhesive force between the light shielding structure and the adhesive of the protective film will also increase accordingly. In this way, the above problems of residual adhesive and scrapping of the filter unit will become more serious.

In order to explore the influence of the inorganic light shielding structure protective layer on the adhesive force between the filter unit and the protective film, the inventor of the present application conducted a comparative experiment. Results show that the ratio (F1/F2) of an adhesive force F1 of the filter unit without the inorganic light shielding structure protective layer to an adhesive force F2 of the filter unit with the inorganic light shielding structure protective layer is about 1.33 after fresh bonding (day 0) and is about 2.15 on the 21st day after bonding. Furthermore, the adhesive force of the filter unit without the inorganic light shielding structure protective layer on the 21st day after bonding is 2.85 times that of the filter unit after fresh bonding (day 0). In contrast, the adhesive force of the filter unit with the inorganic light shielding structure protective layer on the 21st day after bonding is 1.95 times that of the filter unit after fresh bonding (day 0). These results prove that when the inorganic light shielding structure protective layer is formed on the outermost surface of the filter unit, the adhesive force between the filter unit and the protective film can be greatly reduced, and the shelf life of the filter unit affixed with the protective film can be greatly prolonged.

As to the filter unit manufactured by the method for manufacturing a filter unit of the embodiment of the present application, since an inorganic light shielding structure protective layer covers the outer side of the light shielding structure, when the protective film is affixed to the filter unit after shipment, the adhesive of the protective film will not directly contact with the light shielding structure. Therefore, the above problems of residual adhesive of the existing protective film and scrapping of the filter unit can be solved. In summary, as to the filter unit of the present embodiment, through arranging the inorganic light shielding structure protective layer, the optical properties of the light blocking portion are improved, the yield of the final product is greatly improved, and the shelf life is greatly prolonged under a premise of not influencing the optical properties of the light transmitting portion.

It should be noted that the first filter unit A1, the second filter unit A2, the third filter unit A3, the fourth filter unit A4, the fifth filter unit A5, the sixth filter unit A6, the seventh filter unit B1, the eighth filter unit B2, the ninth filter unit B3, the tenth filter unit B4, the eleventh filter unit B5, and the twelfth filter unit B6 mentioned in the embodiments of the present application are all filter units to be protected by the present application, and prefixes such as “first” and “second” are merely used to distinguish the filter units of different embodiments, rather than indicating an order of importance.

In summary, as to the method for manufacturing a filter unit and the filter unit of the present application, through the design of the inorganic light shielding structure protective layer and the like, the light shielding structure can be not prone to be damaged during the subsequent processing processes of the filter unit. In particular, during the cleaning process of the filter unit using plasma, chemical detergent, etc., the light shielding structure is covered by the inorganic light shielding structure protective layer and thus will not be prone to be damaged. In addition, in the method for manufacturing a filter unit and the filter unit of the present application, through a design in which the light blocking portion has a reflectivity of 1% or less for a light beam with a wavelength range of 500 nm to 775 nm when the incident angle is in a range of 0 to 5 degrees, the light shielding structure still maintains relatively good optical properties when covered with the inorganic light shielding structure protective layer.

What is claimed is:

1. A filter unit, comprising:
a substrate;
an organic dye layer arranged on a side of the substrate;
(N-M) inorganic optical layers formed on a side, opposite to the substrate, of the organic dye layer, wherein N>M>0, and N and M are both integers;
a light shielding structure formed on a side, opposite to the substrate, of the (N-M) inorganic optical layers, wherein the light shielding structure defines a region for forming a light blocking portion and a region for forming a light transmitting portion on the substrate; and the light shielding structure is configured to absorb light beams with a wavelength range of 400 nm to 700 nm; and
M inorganic optical layers formed on a side, opposite to the organic dye layer, of the light shielding structure, wherein the M inorganic optical layers cover the (N-M) inorganic optical layers and the light shielding structure;
wherein the light shielding structure and the M inorganic optical layers covering the light shielding structure together form the light blocking portion, and in the light blocking portion, the M inorganic optical layers are used as an inorganic light shielding structure protective layer; and the light blocking portion has a reflectivity of 1% or less for a light beam with a wavelength range of 500 nm to 775 nm when an incident angle is in a range of 0 to 5 degrees; the filter unit has a target center wavelength, and an optical thickness of the inorganic light shielding structure protective layer is between 65% and 120% of one quarter of the target center wavelength, and the light transmitting portion has a reflectivity of 2% or less for a light beam with a wavelength range of 500 nm to 775 nm when an incident angle is in a range of 0 to 5 degrees; and
the substrate located in the light transmitting portion is not covered by the light shielding structure, and in the light transmitting portion, the (N-M) inorganic optical layers and the M inorganic optical layers located thereon are used together as an inorganic optical composite layer.

2. The filter unit according to claim 1, further comprising an auxiliary organic dye layer, an auxiliary inorganic optical composite layer and an inorganic protective layer on a side, opposite to the organic dye layer, of the substrate;
wherein a thickness of the organic dye layer is not greater than 10 microns, and a thickness of the auxiliary organic dye layer is 20 microns or greater; and the inorganic protective layer covers a top surface of the auxiliary inorganic optical composite layer and an auxiliary inorganic optical composite layer annular side surface, and covers at least a portion of an auxiliary organic dye layer annular side surface.

3. The filter unit according to claim 2, wherein a side wall of the filter unit has a step portion, and the step portion is located on a side wall of the auxiliary organic dye layer, or on a side wall of the substrate, or at a junction of the auxiliary organic dye layer and the substrate.

4. The filter unit according to claim 1, further comprising an auxiliary organic dye layer and an auxiliary inorganic optical composite layer on the side, opposite to the organic dye layer, of the substrate;
wherein a thickness of the organic dye layer is not greater than 10 microns, and a thickness of the auxiliary organic dye layer is 20 microns or greater; an organic coking structure is formed in at least a portion of an auxiliary organic dye layer annular side surface of the auxiliary organic dye layer, and the organic coking structure is a structure formed after the auxiliary organic dye layer is irradiated by a laser.

5. The filter unit according to claim 4, wherein a side wall of the filter unit has a step portion, and the step portion is located on a side wall of the auxiliary organic dye layer, or on a side wall of the substrate, or at a junction of the auxiliary organic dye layer and the substrate.

6. The filter unit according to claim 4, wherein an oxygen-carbon ratio of the organic coking structure is 2.46 to 6.92 times an oxygen-carbon ratio of the auxiliary organic dye layer which is not irradiated by a laser.

7. The filter unit according to claim 4, wherein the oxygen-carbon ratio of the organic coking structure is 1.18 to 1.66.

8. The filter unit according to claim 1, wherein when viewed from a cross-sectional direction, an upper side and a lower side of the filter unit respectively have a first width and a second width, and the first width is less than the second width.

9. The filter unit according to claim 8, wherein a difference value between the first width and the second width is 5 to 150 microns.

10. The filter unit according to claim 1, further comprising:
an auxiliary organic dye layer formed on a side, opposite to the organic dye layer, of the substrate;
an auxiliary insulating layer formed on a side, opposite to the substrate, of the auxiliary organic dye layer and covering the auxiliary organic dye layer;
an auxiliary light shielding structure formed on a side, opposite to the substrate, of the auxiliary insulating layer and configured to absorb light beams with a wavelength range of 400 nm to 700 nm; and
an auxiliary inorganic light shielding structure protective layer formed on a side, opposite to the substrate, of the auxiliary insulating layer and covering the auxiliary light shielding structure;
wherein the auxiliary light shielding structure and the auxiliary inorganic light shielding structure protective layer covering the auxiliary light shielding structure together form an auxiliary light blocking portion; and the auxiliary light blocking portion has a reflectivity of 1% or less for a light beam with a wavelength range of 500 nm to 775 nm when the incident angle is in a range of 0 to 5 degrees.

11. The filter unit according to claim 10, wherein when viewed from above, the light shielding structure is aligned with the auxiliary light shielding structure.

12. The filter unit according to claim 1, wherein the light blocking portion has a reflectivity of 0.5% or less for a light beam with a wavelength range of 640 nm to 660 nm when the incident angle is in a range of 0 to 5 degrees.

13. The filter unit according to claim 1, wherein the light blocking portion has a reflectivity of 0.5% or less for a light beam with a wavelength range of 700 nm to 775 nm when the incident angle is in a range of 0 to 5 degrees.

14. The filter unit according to claim 1, wherein two opposite sides of the filter unit are respectively defined as a light incoming side and a light outgoing side, and a side of the filter unit having the light shielding structure is the light incoming side; after a light beam with a wavelength range of 350 nm to 1000 nm enters the light transmitting portion of the filter unit from the light incoming side, a transmittance of the light beam with a wavelength range of 450 nm to 580 nm is 80% or greater, and a transmittance of the light beam with a wavelength range of 750 nm to 1000 nm is 5% or less.

15. A method for manufacturing a filter unit, comprising:
a basic manufacturing step, comprising: forming an organic dye layer on a side of a substrate;
the method for manufacturing a filter unit further comprises the following steps after the basic manufacturing step:
a step of forming a first inorganic optical layer: forming (N-M) inorganic optical layers on a side, opposite to the substrate, of the organic dye layer, wherein N>M>0, and N and M are both integers;
a step of forming a light shielding structure: forming a light shielding structure on a side, opposite to the substrate, of the (N-M) inorganic optical layers, wherein the light shielding structure defines a region for forming a light blocking portion and a region for forming a light transmitting portion on the substrate; and the light shielding structure is configured to absorb light beams with a wavelength range of 400 nm to 700 nm; and
a step of forming a second inorganic optical layer: forming M inorganic optical layers on a side, opposite to the organic dye layer, of the light shielding structure, wherein the M inorganic optical layers cover the (N-M) inorganic optical layers and the light shielding structure;
wherein the light shielding structure and the M inorganic optical layers covering the light shielding structure together form the light blocking portion, and in the light blocking portion, the M inorganic optical layers are used as an inorganic light shielding structure protective layer; and the light blocking portion has a reflectivity of 1% or less for a light beam with a wavelength range of 500 nm to 775 nm when an incident angle is in a range of 0 to 5 degrees; the filter unit has a target center wavelength, and the optical thickness of the inorganic light shielding structure protective layer is between 65% and 120% of one quarter of the target center wavelength, and the light transmitting portion has a reflectivity of 2% or less for a light beam with a wavelength range of 500 nm to 775 nm when an incident angle is in a range of 0 to 5 degrees; and
the substrate located in the light transmitting portion is not covered by the light shielding structure, and in the light transmitting portion, the (N-M) inorganic optical layers and the M inorganic optical layers located thereon are used together as an inorganic optical composite layer.

16. The method for manufacturing the filter unit according to claim 15, wherein after forming the inorganic light shielding structure protective layer, the method for manufacturing the filter unit further comprises at least one cleaning step: cleaning the filter unit; wherein in the at least one cleaning step, the filter unit is cleaned using plasma or chemical detergent.

17. The method for manufacturing the filter unit according to claim 15, further comprising the following steps:
a step of forming an auxiliary light shielding structure: forming an auxiliary light shielding structure on a side, opposite to the organic dye layer, of the substrate; wherein the auxiliary light shielding structure is configured to absorb light beams with a wavelength range of 400 nm to 700 nm; and
a step of forming an auxiliary inorganic light shielding structure protective layer: forming an auxiliary inorganic light shielding structure protective layer on a side, opposite to the substrate, of the auxiliary light shielding structure to cover the auxiliary light shielding structure;
wherein the auxiliary light shielding structure and the auxiliary inorganic light shielding structure protective layer covering the auxiliary light shielding structure together form an auxiliary light blocking portion; and the auxiliary light blocking portion has a reflectivity of 1% or less for a light beam with a wavelength range of 500 nm to 775 nm when the incident angle is in a range of 0 to 5 degrees.

18. The method for manufacturing the filter unit according to claim 15, wherein a thickness of the organic dye layer is not greater than 10 microns, and in the method for manufacturing the filter unit, an auxiliary organic dye layer and an auxiliary inorganic optical composite layer are sequentially formed on a side, opposite to the organic dye layer, of the substrate, and a thickness of the auxiliary organic dye layer is 20 microns or greater; in the step of forming a light shielding structure, the formed light shielding structures are a plurality of annular light shielding structures; and the method for manufacturing the filter unit further comprises the following steps:
a first cutting step: using a first cutting method to cut at least a portion of the auxiliary organic dye layer and the auxiliary inorganic optical composite layer to form a plurality of grooves;
a step of forming an inorganic protective layer: forming an inorganic protective layer such that side walls and bottom surfaces forming each of the grooves are covered with the inorganic protective layer; and
a second cutting step: using a second cutting method to cut along the plurality of grooves to cut off the substrate, the organic dye layer, the inorganic optical composite layer and the inorganic light shielding structure protective layer to form a plurality of filter units; wherein the second cutting method is different from the first cutting method; and at least a portion of an auxiliary organic dye layer annular side surface of the auxiliary organic dye layer comprised in each of the filter units is covered by the inorganic protective layer comprised in the filter unit;
wherein, the basic manufacturing step, the step of forming a light shielding structure and the step of forming an inorganic light shielding structure protective layer are all performed before the second cutting step; the first cutting step is performed between the basic manufacturing step and the second cutting step; and the step of forming an inorganic protective layer is performed between the first cutting step and the second cutting step.

19. The method for manufacturing the filter unit according to claim 15, wherein a thickness of the organic dye layer is not greater than 10 microns, and an auxiliary organic dye layer and an auxiliary inorganic optical composite layer are sequentially formed on a side, opposite to the organic dye layer, of the substrate, and a thickness of the auxiliary organic dye layer is 20 microns or greater; in the step of forming a light shielding structure, the formed light shielding structures are a plurality of annular light shielding structures; and the method for manufacturing the filter unit further comprises the following steps:
a first cutting step: using a first cutting method to cut at least a portion of the auxiliary organic dye layer and the auxiliary inorganic optical composite layer to form a plurality of grooves;
wherein, after the first cutting step, at least a portion of the auxiliary organic dye layer located in the groove is to be formed into an organic coking structure;
a second cutting step: using a second cutting method to cut along the plurality of grooves to cut off the substrate, the organic dye layer, the inorganic optical composite layer and the inorganic light shielding structure protective layer to form a plurality of filter units; wherein at least a portion of a peripheral side wall of the auxiliary organic dye layer of each of the filter units corresponds to the organic coking structure; and
wherein, the basic manufacturing step, the step of forming a light shielding structure and the step of forming an inorganic light shielding structure protective layer are all performed before the second cutting step; and the first cutting step is performed between the basic manufacturing step and the second cutting step.

20. The method for manufacturing the filter unit according to claim 15, wherein the light shielding structure is formed by a printing method, and the inorganic optical composite layer is formed by a sputtering method.
